(19) United States
(12) Patent Application Publication
(10) Pub. No.: US 2008/0140458 A1
(43) Pub. Date: Jun. 12, 2008

(54) Online Booking Method and System

(76) Inventor: Roderick James Moore, San Francisco, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/571,490

(22) PCT Filed: Jul. 4, 2005
(86) PCT No.: PCT/AU05/00976

§ 371 Date: Dec. 5, 2007

(30) Foreign Application Priority Data
Jul. 2, 2004 (AU) 2004903635
Nov. 19, 2004 (AU) 2004906625

(51) Int. Cl. G06Q 10/00; G06Q 30/00

(52) U.S. Cl. 705/5

(57) ABSTRACT

An online booking method for providing bookings for a plurality of service providers (140, 144, 146) which involves providing a plurality of booking links (130, 131) to a plurality of bookable service provider entries (125, 126, 127) for display on a search engine results interface or a directory listing interface, where the booking tags (133) indicate a booking option and include associated booking links (135). A dedicated service provider booking interface is hosted on at least one booking engine (104) and is accessible through one of the booking links (130, 131) after selecting the booking tag (133). The booking engine (104) receives a booking request from a user initiated by user selection of a booking tag (133) on said search engine results interface or directory listing interface. The booking engine (104) then uses the booking request to access the corresponding booking interface which is populated with service provider specific details for enabling users to make a booking.

### FIELD OF THE INVENTION

The present invention relates to an online method for managing bookings for a plurality of service providers and to a system configured to implement the method.

### BACKGROUND OF THE INVENTION

The booking of time based services has begun to migrate from traditional business methods and practices towards computer assisted or enabled practices. The advent of ecommerce and online booking systems for services and facilities typifies this shifting paradigm and may be seen in offices and in the community (for example in doctors' surgeries).

In today's online environment, service providers may be rapidly located through conducting a search of a variety of online directory listings or by using any number of online search engines. The search engine or directory listing provider often receives revenue based on the amount of ‘click through’ traffic generated, particularly in the case where the service provider has paid for a ‘sponsored link.’ The new frontier in directory listings/search engines is in the provision of highly specific results that are tailored to a particular business type in a specific locale—the ‘local search market’. Traditionally the province of providers such as Yellow Pages, the local search market is assuming increasing importance to providers of online search engines and directory listing services with each provider assuming characteristics of the other. In the local search arena therefore there is significant competition to attract and retain user attention and therefore potential revenue associated with the provision of services and advertising.

Accessing a service provider booking page located through searching an online directory listing or an online search engine as set out above may require several levels of convoluted navigation. This navigation may include the steps of entering a search query string, reviewing qualifying search engine results or directory listing results, navigating from these results to the service provider website and then navigating around that site to locate an associated booking facility. Hence, the user is required to make repeated selections of a number of links which is time consuming and frustrating, particularly given the short attention span of today's online users.

Further, online booking facilities are usually service and website specific, resulting in a lack of uniformity and familiarity for the user. For example, navigation, layout and general business processes embodied in specific pages often differ markedly between two online booking sites that offer the same type of service (e.g. two restaurants). An even more marked difference may be seen between two sites of service providers involved in the provision of two different service types (e.g. a restaurant and a financial planner). Often the online booking sites are merely ‘booking request’ sites, and rather than being ‘online realtime’ the online booking channel adds merely an additional booking request facility, without being integrated into the service provider's business.

As the online booking facilities are controlled by the individual service provider, their diligence or otherwise in maintaining their booking facility directly affects the user experience.

Hence, online booking facilities are difficult to access, in particular where service provider details are unknown, and are often characterised by service provider specific idiosyncrasies in both navigation and content.

### SUMMARY OF THE INVENTION

In a first aspect of the present invention there is provided An online booking method for providing bookings for a plurality of service providers including:

providing a plurality of bookable service provider entries with a plurality of corresponding booking links for display on a search engine results interface or a directory listing interface, said booking links including associated booking tags indicative of a booking option;

hosting a plurality of dedicated service provider booking interfaces on at least one booking engine, said booking interfaces being accessible via the corresponding booking links by selection of the associated booking tags;

receiving at the booking engine a booking request from a user, said booking request being initiated by user selection of a booking tag on said search engine results interface or directory listing interface; and

using said booking request to access a corresponding booking interface hosted on the at least one booking engine, said booking interface being populated with service provider specific details for enabling users to make a booking.

Preferably, at least one booking engine includes a centralised booking engine, the method including hosting a plurality of dedicated bookable service provider booking interfaces on said central booking engine and dynamically linking said central booking engine to a corresponding plurality of bookable service providers associated with said dedicated service provider booking interfaces.

Advantageously, wherein the booking links include service provider booking links, said service provider booking links being accessible online via a service provider's website or URL based interface.

The booking links include a booking tag providing a visual representation indicative of a booking option, wherein the visual representation may comprise an icon and the associated booking link may comprise a hyperlink.

Conveniently, the booking interface includes a booking entry interface, a booking results interface and a confirmation interface or display, which may be embodied sequentially on separate booking pages.

The bookable service provider entries with booking tags may be a subset of bookable service provider entries that are included in at least one searchable data source available to a search engine.

The bookable service provider entries are a subset of general directory listing or search engine result entries, including non-bookable entries.

The at least one searchable data source may be populated by a ‘spidering’ or ‘bot’ or ‘web crawler’ type application, wherein the search engine is selected from a group of generic web-based search engines of the type which includes Google®, Infoseek®, Yahoo®, Netscape®, Teoma®, HotBot®, Gigablast®, AskJeeves®, Alta Vista®, AOL Search®, AlLTheWeb®.

The searchable data source may be populated by an indexing search engine, which may be selected from a group of online indexing search engines of the type which includes Yahoo®), Excite®, Infoseek®, Lycos®), MSN Search®, Looksmart®, and Altavista®.

Entries for display on the online directory listing interface include entries for bookable service providers, entries for non-bookable service providers and other entries.

The directory listing is an online listing of the type selected from a group including Whitepages-type listings, Yellow Pages-type listings, OpenDirectory-type listings, City Search®, Whereis®, and Sensis®.

At least some of the booking interfaces are directly accessible from the corresponding booking links by one or two levels of navigation.

A first level of navigation allows the user to review an intervening page containing user information and/or booking terms and conditions, and a second level of navigation may allow the user to make the booking.

The method may include displaying the booking availability of a service provider at the corresponding booking interface and dynamically updating said display.

The booking interface may include a generic booking template which allows individual service providers to populate the interface with service provider specific details, the generic booking template being typically common to at least some service providers of the same type.

The generic booking template may be one of a plurality of generic templates, each generic template being generic to a specific service provider type.

The method may include providing a plurality of searchable entries in a data source associated with a single bookable service provider with the booking link corresponding to that bookable service provider.

The method preferably includes monitoring the selection of booking links in respect of a specific bookable service provider at the search engine interface or directory listing, storing said selection and using selection data stored in respect of each service provider as a basis for a charging model by a search engine or directory listing provider

Conveniently, the method includes monitoring successful bookings in respect of a specific bookable service provider at the booking engine by the search engine or directory listing provider, storing successful bookings data, and using said successful bookings data as a basis for a charging model.

The monitoring may involve conducting a click-through analysis of successful bookings, and storing successful booking related information in a booking log as the basis for the charging model.

The booking interface templates may provide for entry of said booking data including at least first and second booking variables for facilitating booking selection by a user.

The booking interface templates may include a plurality of booking screens or pages which are arranged to provide a similar navigation structure between both the same and differing service provider types.

Where service provider templates differ for different service provider types the user may be able to select a corresponding service provider type via a setup wizard.

Each booking screen or template typically has customisable nomenclature which can be adapted by the service provider for a specific service type, whilst preserving the overall structure or “look and feel” of each screen or template and the transition between successive screens or templates.

In one form of the invention, the method includes dynamically linking each booking interface with a service provider booking site or URL based-link.

The booking engine may monitor booking entries made in respect of a specific service provider, stores booking entry data and uses that data as a basis for a charging model.

Service provider identification information associated with at least one pre-existing service provider entry is correlated to provide at least one correlated service provider entry.

Typically the search engine or directory listing receives remote instructions from a specific service provider, validates said instructions and responds to validated instructions to alter the display state of the booking link.

The booking engine is preferably controlled by the search engine or directory listing provider.

The method preferably includes enabling individual service providers to administer the booking interface provided to the user of the search engine or directory listing.

The directory or search engine provider may generate performance metrics for the information of the service provider.

The administration of the booking interface by the service provider may be monitored by the directory or search engine provider.

The number of times a booking tag is displayed in the search engine or directory listing results page may be captured and compared to the number of times the booking tag is selected by a user.

The number of times the service provider has accessed the online booking facility is monitored by the search engine or directory listing provider.

The search engine provider or directory listing provider monitors the status of the service provider.

The search engine provider or directory listing provider may also monitor the volume of online bookings made for a particular service provider over a predetermined timeframe.

The search engine provider or directory listing provider monitors the number of rescheduled bookings for a particular service provider over a predetermined timeframe.

The invention extends to computer readable media containing program code, the program code being operative to instruct at least one programmable processor to execute the online booking method set out above.

The invention further extends to at least one computer server adapted to execute a method as summarised above.

The invention further provides a booking engine application adapted to run a booking platform as set out above.

In a further aspect of the present invention there is provided a computer-based method for establishing a booking facility for a plurality of different types of service providers having service provider entries, said entries being included in a generic online directory listing and/or being accessible via a search engine, the method including:

providing a booking engine with a plurality of customisable booking interface templates;

enabling a plurality of said different types of service providers associated with said service provider entries to populate said booking interface templates via service provider interfaces with service provider specific booking data to provide a plurality of booking interfaces;

providing said service provider entries with booking links for dynamically linking a service provider entry with an associated booking interface hosted on said booking engine; and

capturing user booking selections associated with a specific service provider at a corresponding booking interface, said booking interface being accessible via a booking link.

In still another aspect of the present invention there is provided An online booking system, for providing bookings for a plurality of service providers including:

means for populating a plurality of bookable service provider entries with booking links for display on a search engine results interface or directory listing interface, said booking links including associated booking tags being indicative of a booking option at least one booking engine for hosting a plurality of dedicated service provider booking interfaces, each of said booking interfaces being accessible by selection of one of the provided corresponding booking links,

input means for receiving at the booking engine a booking request from a user, said booking request being initiated by user selection of a booking tag on said search engine results interface or directory listing interface,

access means on said booking engine for using said booking request to access the corresponding booking interface hosted on the booking engine, said booking interface being populated with service provider specific details for enabling users to make a booking, and

output means for linking said at least one booking engine to a plurality of service provider terminals.

In still a further aspect of the present invention there is provided an online booking system, for providing bookings for a plurality of service providers including:

a data source having a plurality of bookable service provider entries populated with booking links for display on a search engine results interface or directory listing interface, said booking links including associated booking tags being indicative of a booking option and having an associated booking link,

at least one booking engine for hosting a plurality of dedicated service provider booking interfaces, each of said booking interfaces being accessible by selection of one of the provided corresponding booking links,

input means for receiving at the booking engine a booking request from a user, said booking request being initiated by user selection of a booking tag on said search engine results interface or directory listing interface, and

access means on said booking engine for using said request to access the corresponding booking interface hosted on the booking engine, said booking interface being populated with service provider specific details for enabling users to make a booking.

In another aspect of the present invention there is provided a booking platform for providing bookings for a plurality of service providers including:

a booking server including a booking engine application and a booking database for storing a plurality of dedicated service provider booking interfaces, each of said booking interfaces being accessible by selection of at least one of a plurality of provided corresponding booking links, wherein each booking link is associated with a bookable service provider entry for display on a search engine results interface or directory listing interface,

input means for receiving at the booking server a booking request from a user, said booking request being initiated by user selection of a booking link,

access means for using said request to access the corresponding booking interface hosted on the booking server, said booking interface being populated with service provider specific details for enabling users to make a booking, and

output means for linking the booking server with a plurality of service provider sites and for enabling the booking interfaces to be updated via said service provider sites.

In a further aspect of the present invention there is provided a computer-based system for establishing a booking facility for a plurality of different types of service providers included in a generic online directory listing and/or being accessible via a search engine, the system including:

a booking engine including a plurality of customisable booking interface templates;

a service provider interface means for enabling a plurality of said different types of service providers associated with said service provider entries to populate said booking interface templates with service provider specific booking data to provide a plurality of booking interfaces,

a booking provider interface mans for enabling each of said plurality of booking interfaces to be dynamically linked to an associated service provider entry in the corresponding directory listing or search engine by a plurality of corresponding booking links, and

wherein said booking interface means are arranged to enable the capturing of user booking selections, each booking interface being accessible via a booking link.

### BRIEF DESCRIPTION OF THE DRAWINGS

The present invention will now be described by way of non-limiting example with reference to the accompanying drawings in which:

FIG. 1A shows a schematic representation of a booking system architecture according to a first embodiment of the present invention;

FIG. 1B shows a flow chart depicting the steps in an online method for booking a service according to the first embodiment of the present invention;

FIG. 2 shows a flow chart depicting the steps in a sub-process used for presentation of a customised booking interface to a customer which is used in the method of FIG. 1B;

FIGS. 3A and 3B show flow charts depicting the steps in a sub-process used for service providers to update their details in two alternate embodiments of the present invention; and

FIGS. 4-15 show various web pages comprising a web page interface to an online booking system according to the first embodiment of this invention.

FIG. 16 shows a start page, which may be used to allow a service provider to specify a particular industry type for an online configuration wizard.

FIG. 17 shows a business details interface that allows a service provider to enter standard business information and in the example shown is a Hair/Beauty provider.

FIGS. 18 shows a business details interface that allows a service provider to enter their standard business information and in the example shown is for a restaurant service provider.

FIG. 19A and 19B show pages that allow a service provider to nominate and edit the services provided.

FIGS. 20A and 20B show interfaces that allow the service provider to specify a second service variable —staff members and tables respectively.

FIG. 21A shows a configuration interface for a hairdresser that allows a service provider to specify the linkage between the first service variable and the second service variable.

FIG. 21B shows a preview screen to allow a service provider to review their configuration.

FIGS. 22A, B and C show settings interfaces which allow the service provider to specify default settings for communication and other additional information.

FIG. 23 shows a booking interface, which allows a service provider to review all bookings including new online bookings.

FIG. 24 shows a booking interface (calendar view) for all available timeslots and all bookings for a particular day.

FIG. 25 shows a masking template window to enable service providers to ‘mask out’ selected times so that these times are not available for online bookings.

FIG. 26 shows a child window which may be used to create a new booking, or edit the details for an existing booking as well as changing the status of a booking.

FIG. 27A shows an interface for a hairdresser which allows a service provider to specify and/or nominate and edit the services provided.

FIG. 27B shows a child popup window through which the service provider can add/edit the services provided.

FIG. 27C shows a service setup interface that allows a service provider to customise the availability and identification of the resources available.

FIG. 27D shows a child popup window derived from FIG. 27C which allows the service provider to edit service categories.

FIG. 27E shows a child popup window derived from FIG. 27C which allows the service provider to add/edit a resource for a particular group.

FIG. 27F shows a child popup window derived from FIG. 27C which allows the service provider to customise the availability of a particular resource.

FIG. 27G shows a configuration display which allows a service provider to associate services with specific resources.

FIG. 28 is a child popup window which allows a service provider to preview the view the customer observes.

FIG. 29 shows an availability interface that allows a service provider to specify operating and non-operating times and dates.

FIG. 30 shows an interface which allows a service provider to specify online lead times and how new bookings are notified to the service provider.

FIG. 31A shows a customer messages interface that allows a service provider to specify and edit the content of messages provided to a customer in the customer confirmation page and settings for customer reminders.

FIGS. 31BE show preview and edit screens of email and SMS reminder settings and additional information popup windows. FIGS. 32A, 32B and 32C show customer booking interfaces which allow a customer to specify their selection of first and second booking variables.

FIGS. 33A, 33B and 33C show a contact details interfaces that capture a customer's contact information and special requests.

FIGS. 34A, 34B and 34C show review screens that allow a customer to review their booking details before confirming the booking.

FIGS. 35A, 35B and 35C show a booking confirmation screens.

FIG. 36 shows a high level architecture diagram of an embodiment of the present invention, and

FIG. 37 shows a representation of typical bookings data which is accessed by an availability algorithm to determine available booking times.

### DETAILED DESCRIPTION OF THE EMBODIMENTS

It will be understood that the invention disclosed and defined in this specification extends to all alternative combinations of two or more of the individual features mentioned or evident from the text or drawings. All of these different combinations constitute various alternative aspects of the invention.

In the preferred embodiments described, the present invention provides an online booking method and system for providing bookings for a plurality of service providers, by hosting corresponding service provider booking interfaces on at least one booking engine where those interfaces are accessible from user selection of one or more booking tags displayed on a search engine results interface or directory listing interface.

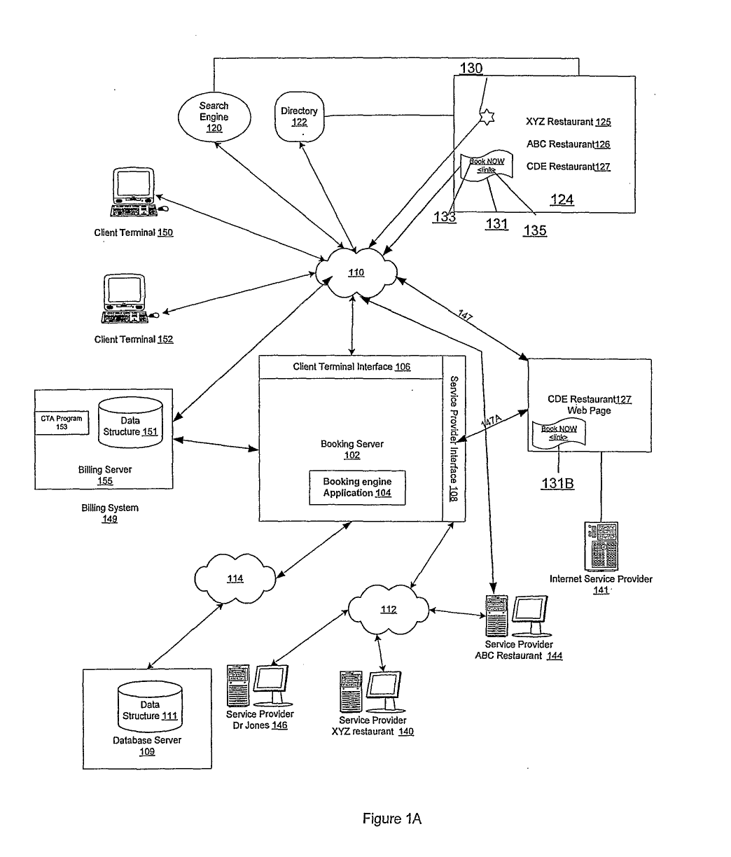

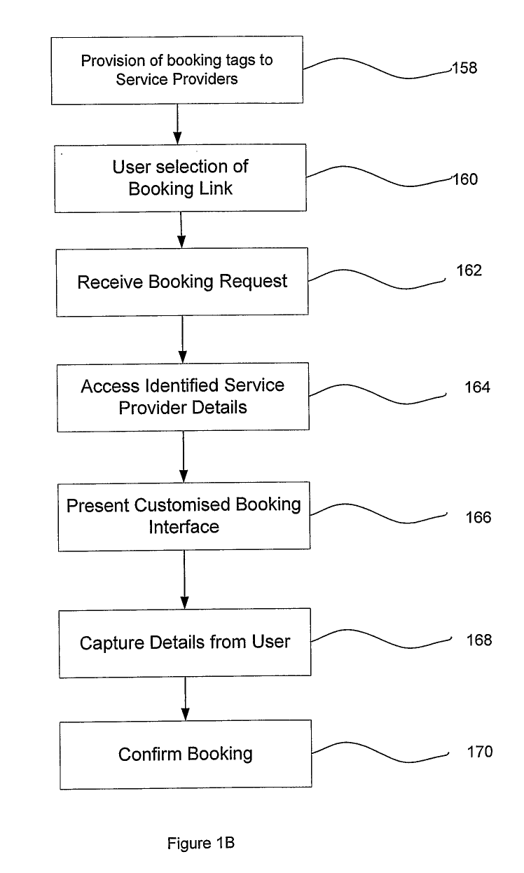

FIG. 1A shows a schematic representation of a system configured to implement a computerised method for booking services according to an embodiment of the present invention. The system may include a booking server 102 configured to run a central internet booking engine application 104 for allowing any one or more of services offered by service providers 140,142,144,146 to be booked by users of client terminals 150 and 152. The client terminals 150 and 152 are connected to the booking server 102 via a computer network 110.

The client terminals 150 and 152 are in communication with a search engine 120 and an online business directory listing 122 through computer network 110. The computer networks 110 or 112 or 114 or 115 may be the internet or other wireless or wired computer network such as a LAN, WAN or the like. The search engine 120 or the business directory listing 122 can generate a qualifying service provider listing 124 in accordance with criteria provided by the customer. The qualifying service provider listing 124 is made up of entries 125,126 and 127 corresponding to a number of service providers 140,142 and 144. At least some entries include booking links 130, 131 that provide a hypertext URL-based link to a corresponding booking engine 139 or 104.

Alternatively, it would be appreciated by a person skilled in the art that the ‘book now’ link 13B may simply be provided to a service provider for inclusion in their website, hosted through by their conventional internet service provider 141.

These booking links comprise a visual representation that is capable of clearly indicating to a user that the associated booking link may be used directly for making a booking of the service provider. By way of non limiting example, in booking link 131 the visual representation may be a small image representing a booking option or instruction or words (e.g. ‘Book now’) 133 booking tag, along with an accompanying, typically underlying, hypertext link 135. The visual representation may itself comprise the link where the booking instruction is visibly embodied in the link (not shown).

The associated booking link may link to a specific service provider interface on the central booking engine 104, where that booking engine is capable of hosting a plurality of bookable service provider interfaces. The associated booking link may also link to a central booking engine application 104 The booking server 102 are in data communication with database server 109. Database server 109 includes a data storage structure 111 which stores details for each of a plurality of service providers. The booking server 102 includes a client terminal interface program module 106 and a services terminal interface module 108 which allows the booking server 102 to communicate with the one of a series of client terminals 150 and 152 and one of a series of service providers 140, 141, 142, 144 and 146 respectively. In the figure, by way of example, 140, 142 and 144 are some of a series of bookable restaurants and 146 is one of a series of bookable doctors. However, these are non limiting and a person skilled in the art would appreciate that the service providers could include any bookable service provider ranging (for example) from a restaurant to a hairdresser, an accommodation provider or even a mechanic. A service provider can include a provider of both goods and services.

The system may also include a billing system 149 which is in communication with one or both the booking engine 104 and the search engine 120 or directory listing 122. The billing system 149 comprises a data structure 151, and a click through analysis program 153 configured to run on a billing server 155. The click through analysis program (CTA program) 153 is adapted to monitor and record in the data structure 151, user selection of booking tags provided to bookable service providers.

Monitoring may be conducted by capturing user selections at a search engine or directory listing level; or by capturing only successful bookings made through the use of the central booking engine. In either situation, the information stored in the booking log may then form the basis of a charging model.

Several charging models may be employed. Where the online search engine or directory listing business also provides a booking engine the service provider may pay the operator of the search engine or directory listing for provision of the booking tag and the booking engine. Alternatively, the service provider may pay the operator of the booking engine a fee, and the operator of the booking engine may then remit a percentage of this fee to the operator of the search engine or directory listing as payment for the provision of the booking tag. In still another alternative charging model, the service provider may pay to the operator of the search engine or directory listing a fee, a percentage of which is remitted to the operator of the booking engine.

A flowchart depicting the broad steps in a process in accordance with an embodiment of the present invention that can be implemented using an online booking system is depicted in FIG. 1B.

The process begins by the provision of booking links to a plurality of service provider entries in a directory listing or a data source accessible to a search engine Alternatively, these links may be provided to a service provider directly, for inclusion in their web page hosted by any internet service provider. (step 158). As is set out above, these tags contain a visual representation 133 identifying their nature as booking links, and a link 131 to a corresponding service provider booking interface hosted on at least one booking engine 104.

Once a customer reviews the entries listing displayed on the search engine results interface or a directory listing interface and decides they wish to make a booking for one of the service providers that has an associated booking tag, the customer makes a booking request by selecting the booking link (step 160) from the booking tag. Alternatively, the customer may select the booking tag and associated booking links from the service provider website.

Depending on the configuration, the booking request may be received at the client terminal interface 106 of the booking server 102 (step 162).

The booking engine then accesses an associated database 109 (step 164) over the LAN, internet, or network (114 ) to retrieve relevant service provider details from the relevant data structure. The booking engine then generates (step 166) a customised booking interface incorporating the relevant service details and presents it to the client terminal through the client terminal interface. The user makes selections from the booking interface (step 168) which provides relevant contact information and on the completion of a successful booking is sent confirmation details (step 170).

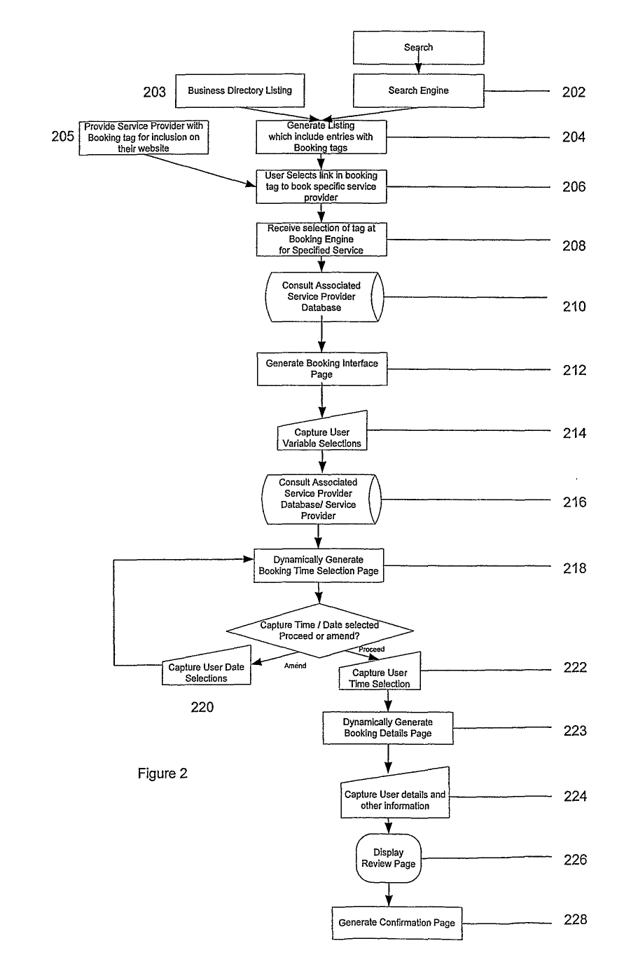

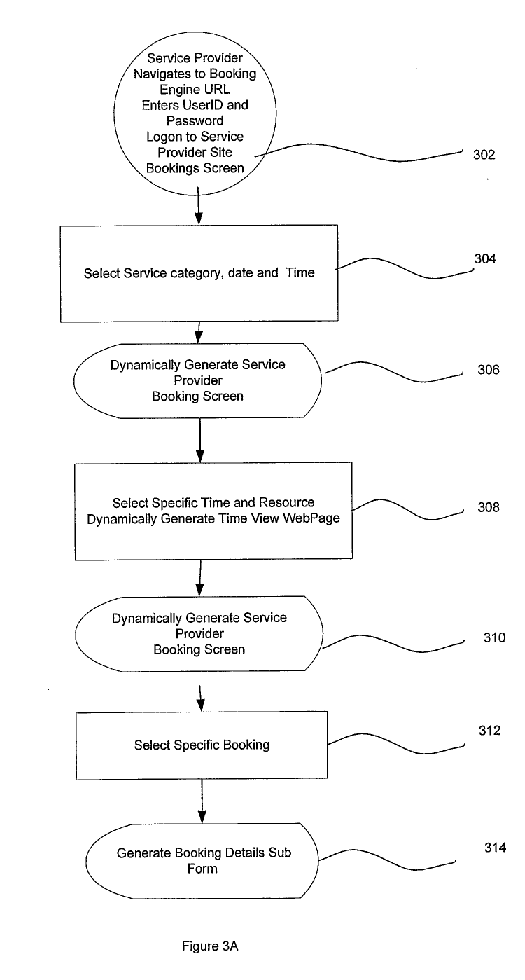

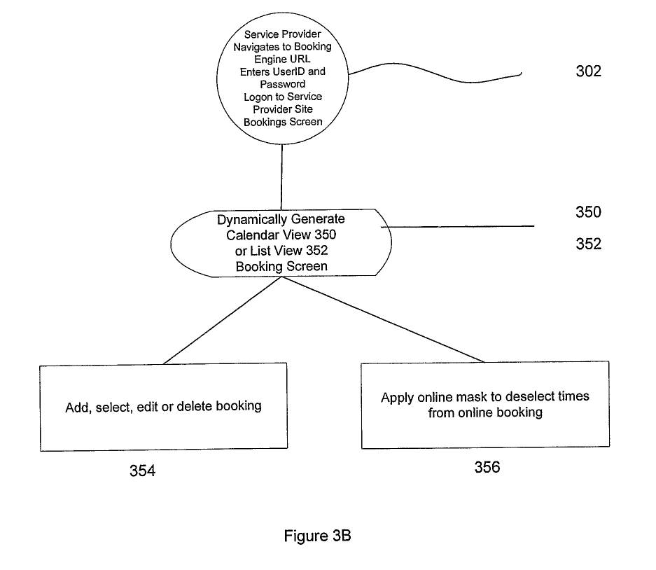

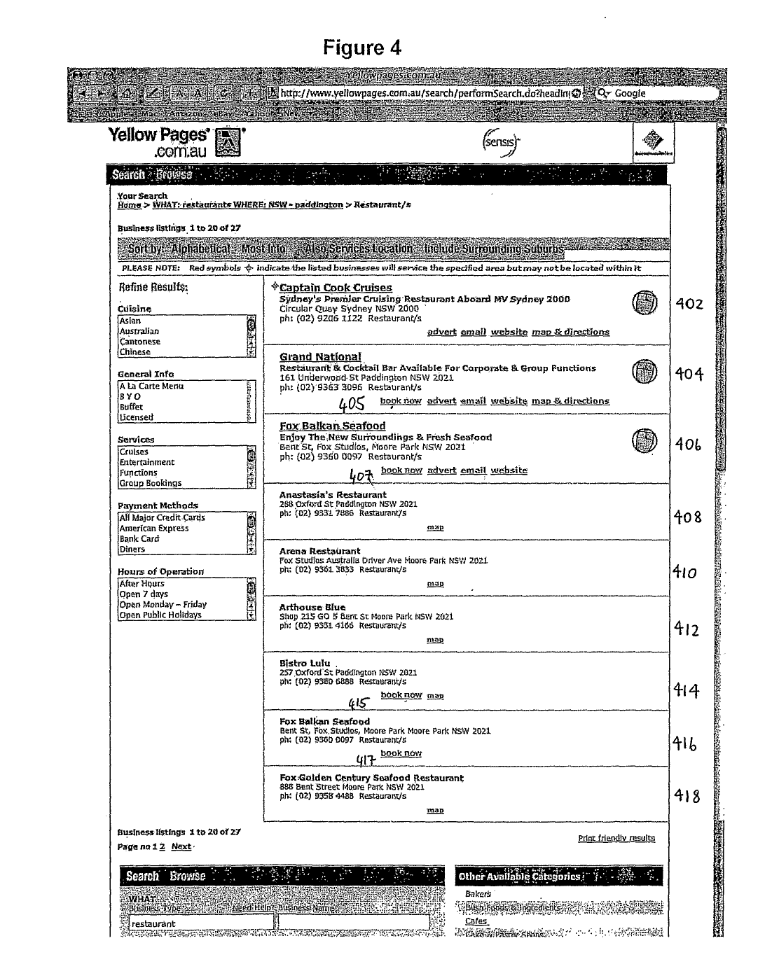

A preferred implementation of the method will now be described in connection with the flow charts of FIGS. 2 and 3. To assist in understanding the steps of the method, reference will be made to FIGS. 4 to 15 which show screen images of suitable customer interfaces to the booking engine which implements the online booking method. As will be appreciated by those skilled in the art the online booking engine is preferably implemented using a web page interface as disclosed in FIGS. 4 to 15 and will typically be accessed by a client by using a web browser running on a personal computer or workstation.

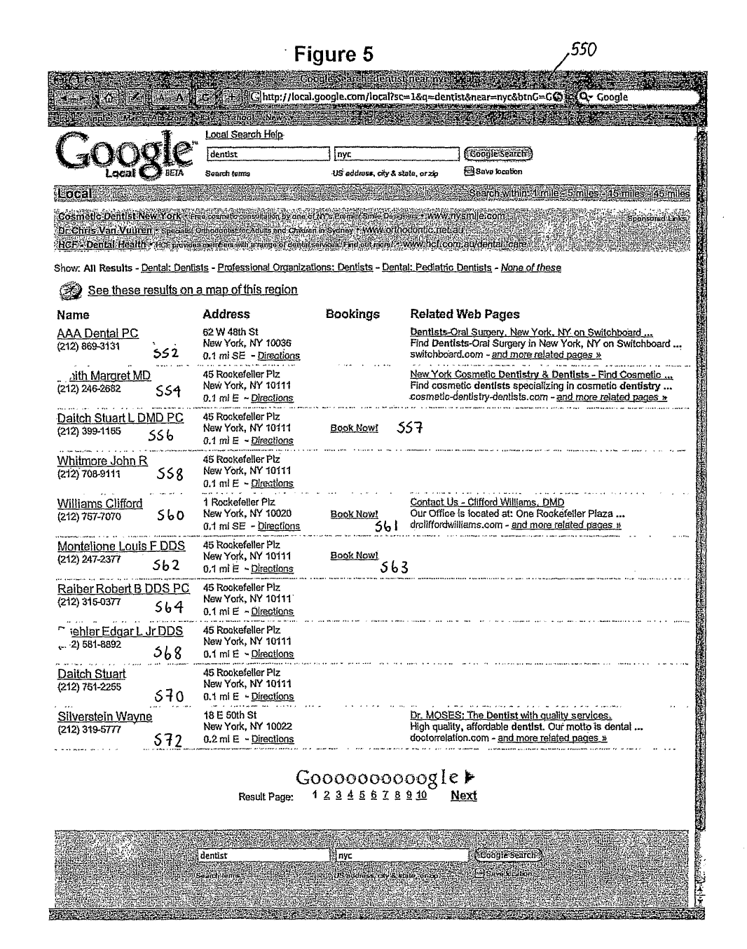

The process of FIG. 2 begins in one of three ways.

Where a customer doesn't know the specific web address of the service provider, but knows the type of service that they require, they either enter an appropriate search string into a search engine (step 202) or alternatively look up an online directory (step 203). In either situation they initiate a search which results in the generation of a qualifying service provider listing in a search engine results interface or directory listing interface (an example of which is shown broadly at 124 in FIG. 1 and in FIGS. 4 and 5) (step 204).

An example of a directory listing results interface is shown in FIG. 4. This directory listing interface is generated in response to user entry of a query string —the restaurants in Paddington—into a yellowpages.com.au search engine interface.

A directory listing results interface page 400 includes a number of bookable service provider entries for restaurants 402, 404, 406,408,410,416,418. Of these 404,406, 414 and 416 are service provider entries which include corresponding booking tag 405, 407,415 and 417; which are capable of linking to the booking engine 104 (or 139 depending on the configuration) to enable access to the corresponding booking interface. The other entries are bookable service providers but which do not include a booking tag, however are still displayed on the directory listing interface in response to user specified criteria.

An example of a search engine results interface is shown in FIG. 5. This interface is generated in response to a user executing a search using specified search criteria. In the figure this comprises the user entering a query string—‘dentists in NYC’ into a Google search engine interface.

A web page 550 is in the form of a search engine results. The web page 550 includes a number of bookable service provider entries 552, 554, 556, 558, 560, 562, 564, 568, 570,572. Of these, entries 556, 560 and 562 are service providers which include a corresponding booking tag 557, 561,563 capable of linking to the booking engine 104 (or 139 depending on the configuration) to enable access to the corresponding booking interface. The other service provider entries are bookable service providers which are also displayed on the directory listing interface in response to user specified criteria.

Alternatively, as set out in step 205, the service provider may be provided with a booking link by the search engine or directory listing provider for inclusion in their website hosted either by the Service Provider or outsourced to a commercial internet service provider. The website may be accessed by a user from the search engine or directory listing, or entered directly as is well known to a person skilled in the art.

A customer may then select a booking link corresponding to their desired bookable service provider (step 206), this selection being made either from the results interface or (if applicable) from the website of the service provider.

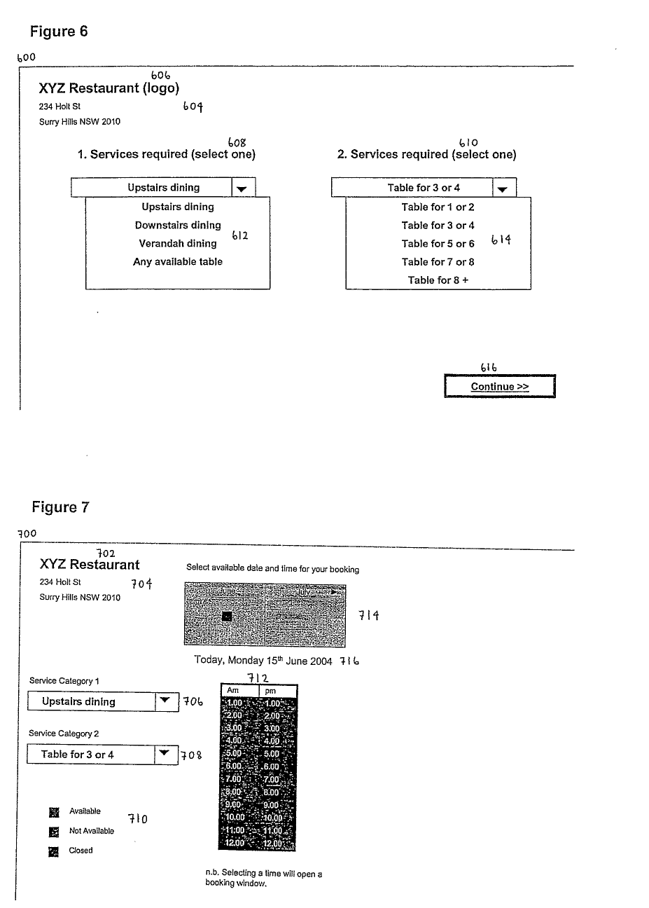

In step 208 the referral request is received by the client terminal interface of the booking server and referred to the booking engine. The booking engine then consults the database server (step 210) and retrieves the details entered for the specified service provider using these details to dynamically generate an appropriate booking interface in step 212. An example of a booking interface is shown in FIG. 6.

The booking interface 600 has a generic format or look and feel irrespective of industry type (in FIG. 6 restaurants); with some aspects (eg the service provider name and address 604 and logo 606) customisable by specific service providers. The interface 600 also includes two service related variables 608 and 610, each of which contain the range of values 612 and 614 customisable by the specific service provider. The interface may also include a hyperlink to the service provider website (not shown). Overall navigation of the booking interface remains consistent, with a standardised navigable template provided by the search engine or directory listing operator, and under their control. At step 214, the client selects variables and clicks the continue button 616 to continue to the next screen.

Before the next screen is presented, at step 216, the booking engine accesses the booking records of the service provider for the date when the booking request is made, and at step 218 dynamically generates a Booking Time Selection screen 700, an example of which is shown in FIG. 7. The Booking Time selection screen includes the following fields:

### Service Contact Details (702) and Service Logo (704)

This text field indicates the service requested, provides the address details and the service provider logo.

### Customer Variable Selection (706) and (708)

These text fields indicate the values for variables 612 and 614 specified in step 208 by the customer.

### Legend(710)

The availability legend indicates the colours used in the time view to indicate various states of a booking—including available, not available and closed.

### Calendar (714), Caption (716) and Time View (712)

The calendar and time fields are used by the customer to specify the date and time that they wish to use the service selected. The default date is set for the date at which the page is accessed. The time fields are coloured according to the booking status legend, for the default date for the specified service provider. The customer can specify another date by clicking on the calendar view, or alternatively select an available time for the day displayed.

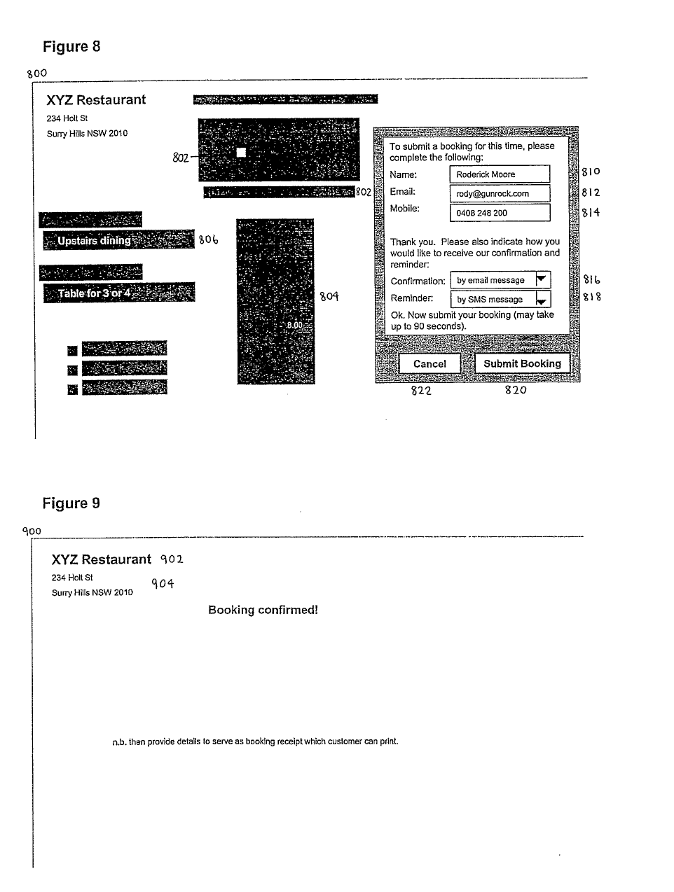

If the customer selects another date (step 220) on the Booking Time Selection screen the process returns to step 218 and a Booking Time Selection Screen is generated for the specified date. Alternatively, if the customer selects an available booking time on the date displayed, it is captured in step 222. A Booking Details Screen 800 is then generated in step 223 and presented to the customer in a new window (an example is shown in FIG. 8). The Booking Time Selection screen 700 remains open in the background and may be accessed by the customer.

The Booking details screen includes all fields of the Booking Time Selection Screen. On the web page 800, the customer selections for date (802), time (804) and variable values (806 and 808) are highlighted to emphasise the selections made by the customer.

Additionally, the Booking Details Screen includes a Customer Details capture form which prompts the customer to enter the following details.

### Customer Details

Name (810), email address (812) and mobile number (814) text boxes allow the customer to specify appropriate contact details.

### Additional Information

Customers can enter additional information into the text box—e.g. if they require wheelchair access or have other special requirements. (Not shown)

### Confirmation/Reminder

Customers may also specify if they require a confirmation email or Short Message Service (SMS) reminder or in the alternative a reminder sent to the contact details provided by selecting these options from drop down menus 816 and 818.

Credit card details may be required by some service providers before establishing a booking. If this is the case, one or more additional text box fields (not shown) may be used to capture this information from the customer.

Once customers have entered appropriate details, a booking may be made by clicking on the submit booking button 820 and captured in step 224. Alternatively if the customer changes their mind or wishes to return to the Booking Time Selection Screen, they may click on the cancel button 822.

After selecting the submit button, the screen may be updated with a temporary page indicating the request is being processed step 226, and a final printable confirmation page 900 is then generated (FIG. 9) step 228.

The printable confirmation page 900 displays details including the service provider contact details 902 and logo 904, as well as a booking details 906 and a booking number not shown which may be used to identify the booking. Terms and conditions and disclaimer(s) (not shown) may also be displayed. A link to the relevant business provider's website may also be displayed (not shown).

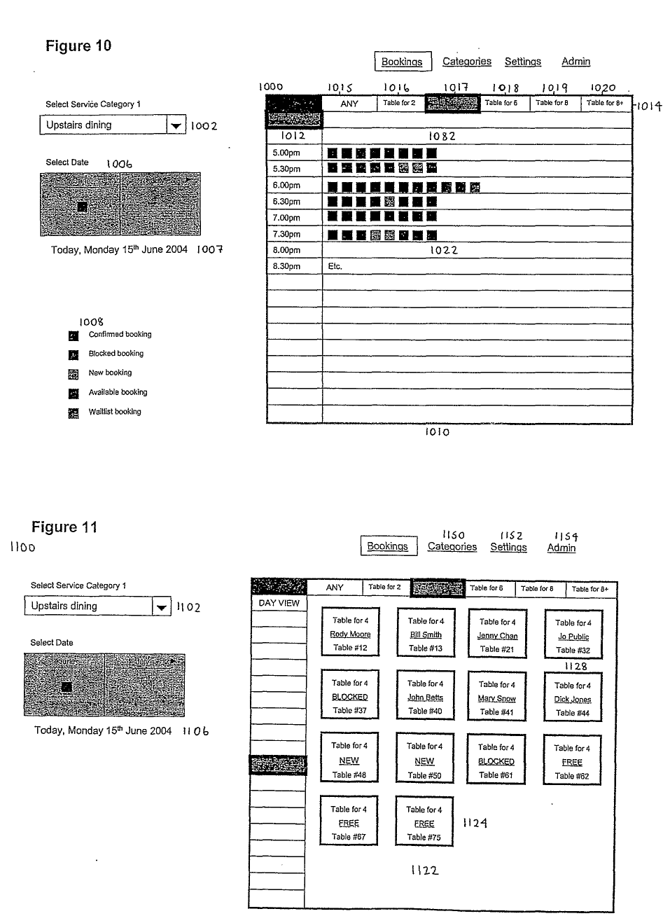

Another aspect of the present invention is the interaction that a service provider has with the online booking system. A flowchart depicting typical steps in service provider interaction in a process of reviewing bookings according to one embodiment of the present invention is depicted in FIG. 3. This flowchart may be read in conjunction with FIGS. 10-15.

A service provider accesses the booking engine by entering the web address of the booking engine into a web browser, which then accesses the chosen address and displays to the user the homepage of the booking engine. This page will typically include information and advertising screen regions, as well as a login area. The login area includes text boxes for capturing name and password details in a web page (not shown). These details are then validated against previously stored entries for that user in any of a variety of known ways as will be appreciated by those skilled in the art.

If the service provider login is successful, the service provider is then able to access subsequent pages of the booking engine. In the example embodiment the first initial screen after a successful login is the Bookings Screen (shown in FIG. 10) (step 302) of FIG. 3A. In a further embodiment (as set out with reference to FIG. 3B and FIGS. 23-26) once verified, the service provider may be able to review and edit existing bookings, using either the list 352 or calendar view 350 screens to add 354 an additional booking, or apply an online mask 356 to deselect timeslots from consideration for online bookings.

The web page 1000 of FIG. 10 includes a “drop down” service category selection field 1002 which allows the service provider to specify a value for a previously specified service category. It also includes a calendar 1006 which allows a service provider to specify a date of interest (step 304), where the default value is set to today's date 1037. A legend 1008 indicates the colours used to indicate various booking states in a grid of bookings 1010. The web page 1000 also includes a menu bar 1080 which contains links to other sub pages; including categories, settings and administration 1050, 1052,1054 respectively in a manner well known in the art.

Column one 1012 of the grid 1010 sets out an indicative time range. Row one of the grid 1014 includes a number of columns displaying text. The column names are associated with variables previously specified by the service provider (1015, 1016, 1017, 1018, 1019, 1020). Each of these columns are selectable by the service provider. The time range and column headings are indicative only and their number and value may be customised by the service provider.

In the web page of FIG. 10, column 1017 has been selected. This selection triggers dynamic interrogation of the booking engine to determine bookings for the specified service category 1002 on the specified date 1004 for the selected column value 1017. In the web page of FIG. 10, this selection corresponds to all tables for four booked in the upstairs dining area for Monday 15 Jun. 2004. The results of the dynamic interrogation (step 306) are presented visually in the body of the grid 1082 with each booking for a specific time represented as a small square 1022, which is coloured in accordance with the legend 1008 to represent booking status.

The web page of FIG. 10 therefore allows a service provider to receive a rapid visual representation of bookings for their service displayed in the body of the grid area 1082 by selection of alternative values for service categories, dates or service variables.

If a service provider is interested in bookings for a particular time, they are able to select that time value (Step 308) from the first column 1012 of the grid 1010 on the web page of FIG. 10. Selection of a specific time value queries the booking engine and presents the service provider with a dynamically generated page as shown in FIG. 11, (step 310).

FIG. 11 sets out a Time View web Page 1100 which is in a similar format to the Bookings enquiry screen of FIG. 10. It includes a “drop down” service category selection field 1102 which highlights the currently selected value for a specified service category and which may be changed by the user. The web page 1100 also includes a calendar 1106 which displays the currently selected date which may be altered to allow a service provider to specify a date of interest. The web page 1100 also includes a menu bar 1190 which includes links to other sub pages; including categories, settings and administration 1150, 1152,1154 respectively in a manner well known in the art.

Column one 1112 of the grid 1110 sets out an indicative time range, with the time selected by the user in FIG. 10 being the only entry retained. Also in accordance with FIG. 10, row one of the grid 1114 includes a number of columns displaying text. The column names are associated with variables previously specified by the service provider (1115, 1116, 1117, 1118, 1119, 1120). Each of these columns are selectable by the service provider. The time and column headings are indicative only and their number and value may be customised by the service provider.

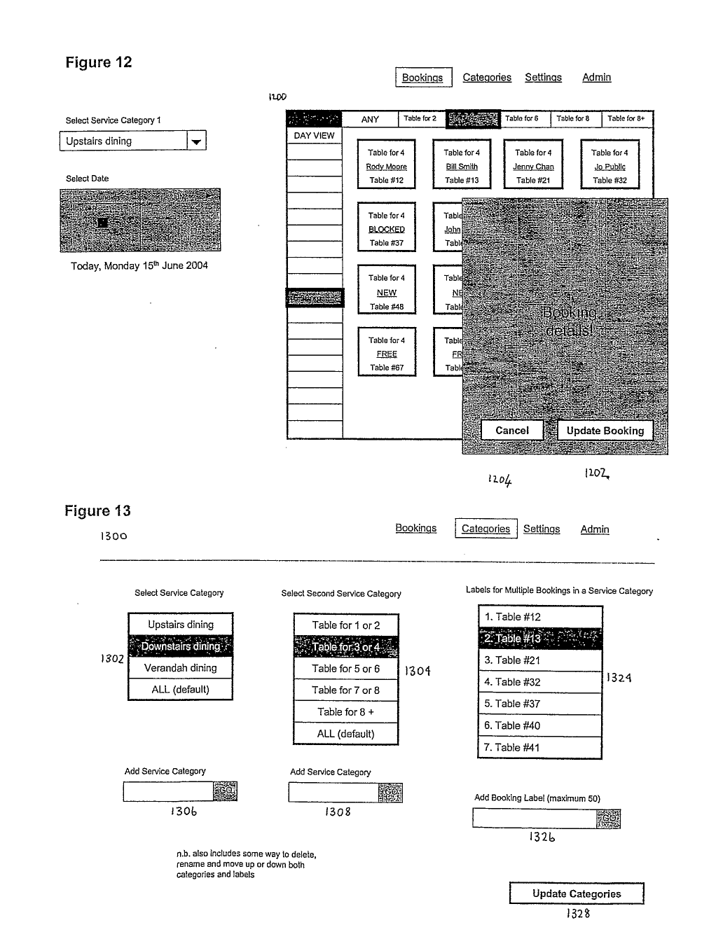

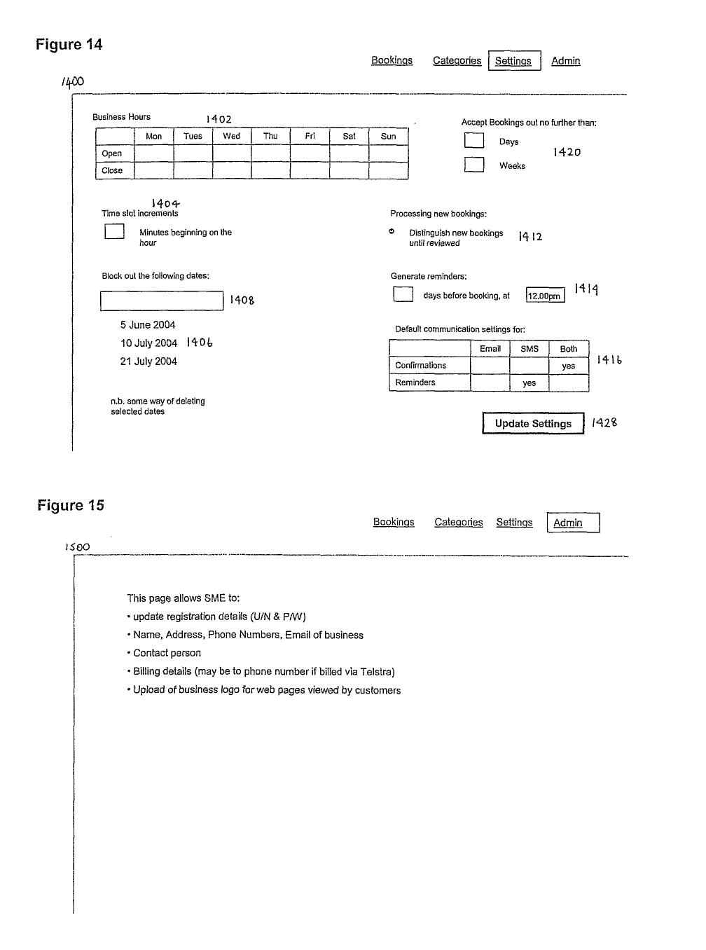

The body of the grid 1122 displays a representation of a plurality of booking entries made in the specified service variable 117 for the previously specified date, time and service category. Each booking displays the service variable, customer name or booking status and table number and a link to the appropriate Booking Details sub form. For example booking 1128 is a table for four, booked by Dick Jones on table 44 for 6.30 pm in Upstairs dining on Monday 15 Jun. 2004. Similarly 1124 is a table for four, table 75 which is currently free.

Where a service provider wishes to review or otherwise modify a booking entry, they may select the link (step 312) which will query the associated booking record in the booking engine, and produce the dynamically generated booking sub form 1200, shown in FIG. 12. The Booking details sub form is presented (step 314) while the Time View Form remains in the background. The Booking details sub form contains text boxes which contain information recorded for a customer who has made a booking, who has for example entered the details set out in FIG. 8. These details include name, email address, mobile number, confirmation details and reminder details. The text fields may be modified by the service provider and the changes captured by clicking the update button 1202 or discarded by clicking the cancel button 1204.

Where a service provider initially configures or subsequently wishes to modify the categories displayed on their related booking interface, they may select the categories link from the page they are currently reviewing. The Categories web page 1300 (an example of which is shown in FIG. 13) includes two lists displaying service categories currently associated with the service 1302, 1304 and two text fields 1306,1308 in which an additional service categories may be entered. Further, if the service provider permits multiple bookings, a table showing the labels currently being used for multiple bookings is set out at 1324. The service provider also has the capacity to specify additional labels for multiple bookings in text field 1326. All changes are committed to the database records stored by the booking engine by selection of the update categories button 1328. Not shown in FIG. 13 is a means by which categories may be deleted, renamed or reordered, but several methods of implementation are well known to a person skilled in the art.

Where a service provider initially configures or subsequently wishes to modify the settings of their related booking interface, they may select the Settings link from the page they are currently reviewing and will be presented with a Settings Page as shown in FIG. 14.

The Settings Page 1400 is a web page that captures service provider specific operational information which is stored in the associated database and which is used to dynamically generate a service provider specific booking interface. The Settings Page 1400 includes a table 1402 in which a service provider is able to enter their opening and closing business hours. It also includes a text box 1404 in which a service provider can enter the time slot increments they desire (e.g. 30 minute blocks each hour). A list of dates on which no bookings will be taken is displayed 1406, as well as a text box 1408 which allows service providers to add additional dates on which the service will be unavailable. Not shown in FIG. 14 is a means by which unavailable dates may be deleted, renamed or reordered, but several methods of implementation are well known to a person skilled in the art.

A radio button 1412 is included allowing the service provider to specify that new bookings are displayed differently (e.g. in a different colour) on the Bookings and Bookings Time View Screens. A service provider may also specify how far in advance booking are accepted and when reminders are generated by entering a value in text boxes 1414 and 1420 respectively. Selection of the means for issuing confirmations and reminders (email or SMS or both) may be recorded by a service provider in a table 1416. All details are committed to the database records stored by the booking engine by selection of the update categories button 1428.

Where a service provider initially configures or subsequently wishes to modify their settings they may select the Administration link from the page they are currently reviewing and will be presented with an Administration Page as shown in FIG. 15. The Administration Page 1500 has text boxes (not shown) that can capture contact details (Name, Address, Phone Number, Email Address of Business, Appropriate Contact Person, Billing Details) as well as a table displaying the information currently stored in the database. The table is dynamically populated with data from the database of the booking engine. Service providers may also specify a new or alternate password or userid by entering appropriate values in a password text box (not shown).

A facility is also provided on the Administration Page for service providers to upload a small logo to the database associated with the booking interface. The Administration Page 1500 may have a link (not shown) that initiates a pop-up File chooser utility, with an interface similar to Windows Explorer®. The service provider is then able to navigate to an appropriate file that contains their logo, chose to attach that file and then select upload in a manner well known to persons skilled in the art. The uploaded logo file would then be stored in the database associated with the booking engine, and accessed in order to generate a customised booking interface for that service provider.

The online booking system of an embodiment of the present invention provides a consistent booking experience to customers booking a service after selecting the booking tag from the resultant list of at least one qualifying service provider displayed after a search has been conducted through an online search engine or directory listing. At the same time, the online booking system allows service providers of all types maximum flexibility to tailor the booking engine to their specific business needs—either online or through conversations with directory or search engine providers or their representative, whilst ensuring a consistent user experience. The booking system is flexible enough to provide booking services for a wide and diverse range of service providers such as hairdressers, doctors, accommodation providers, mechanics and restaurants. Initially, the service provider configures their details by contacting the directory or search engine provider and directly or indirectly filling out an online wizard. The online wizard is used by a service provider to provide the required details to the booking system operated by the search engine or directory listing. This wizard may be accessed either directly by a Service Provider accessing the website over the Internet, or alternatively, by a telephone call centre operator, manually keying in details in response to a conversation with the customer. The wizard can form part of an online offer to service providers, to minimise or eliminate human involvement in product sign-up or system setup.

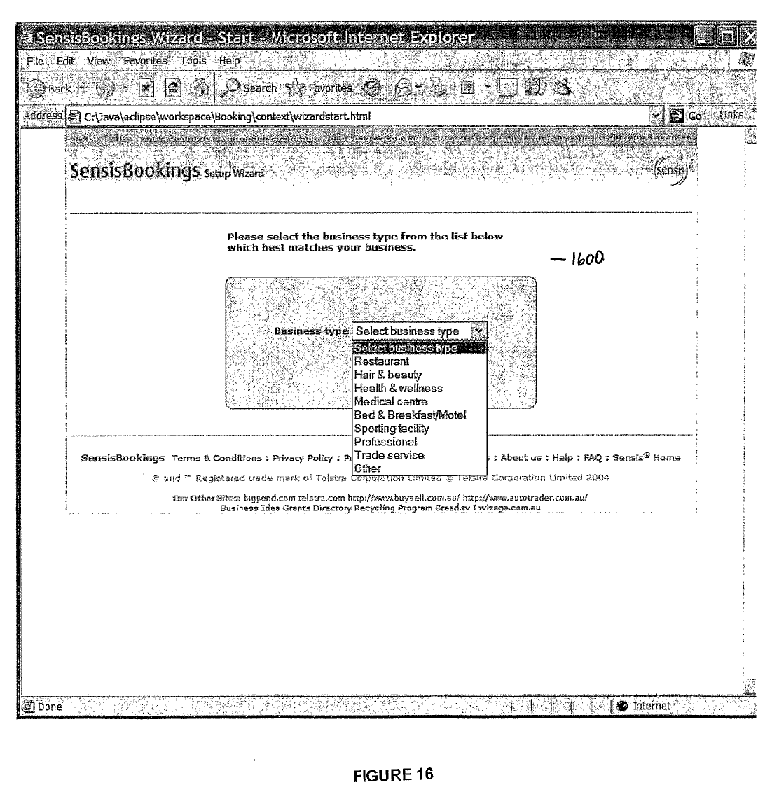

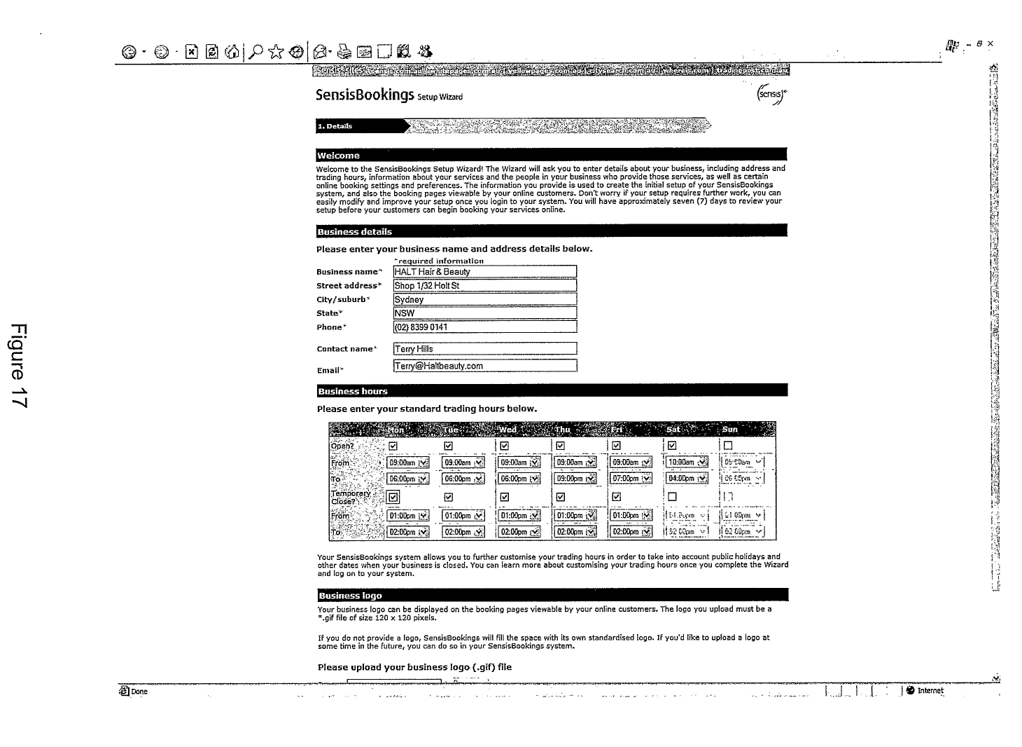

Referring now to FIG. 16, the start interface 1600 may be displayed to allow a service provider using the Setup wizard to select a particular business type, and corresponding template. In the alternative, a Directory or Search engine provider may simply redirect service providers to a generic configuration page, depending on how their business model works.

Referring now to FIG. 17, a business details interface 1700 is displayed in an online wizard in one embodiment of the present invention. This wizard is largely independent of service provider type, however text and input tables may be customised according to the service provider type. The overall format of the wizard therefore caters for virtually all service providers, from hairdressers to restaurants and accommodation providers. Shown here by way of non limiting example only is configuration of a hair and beauty service provider.

The business details interface 1700 may be a standard Hypertext Markup Language Interface (HTML) interface of the type shown, comprising multiple text labels 1702 and corresponding text fields 1704 which may be populated by the user with respective hairdresser and restaurant details, and a continue button 1706 which may also be selected by the user. In accordance with popular usage, the mandatory fields are marked by an asterisk 1708. The context which the user currently occupies is displayed through the use of coloured chevron tabs 1710 at the top of the screen, which serve a ‘breadcrumb’ role. As is well known in the art, as the user progresses through each stage, the current context of the user is reflected in the use of colour for the relevant tab. The user is able to supply business information, including standard trading hours in the table provided 1720. The service provider is able to specify the day and time range which they are open through the use of drop down selections and radio or check buttons. Selection of the continue button stores the information in a temporary data store, and presents the user with the a services offered screen interface.

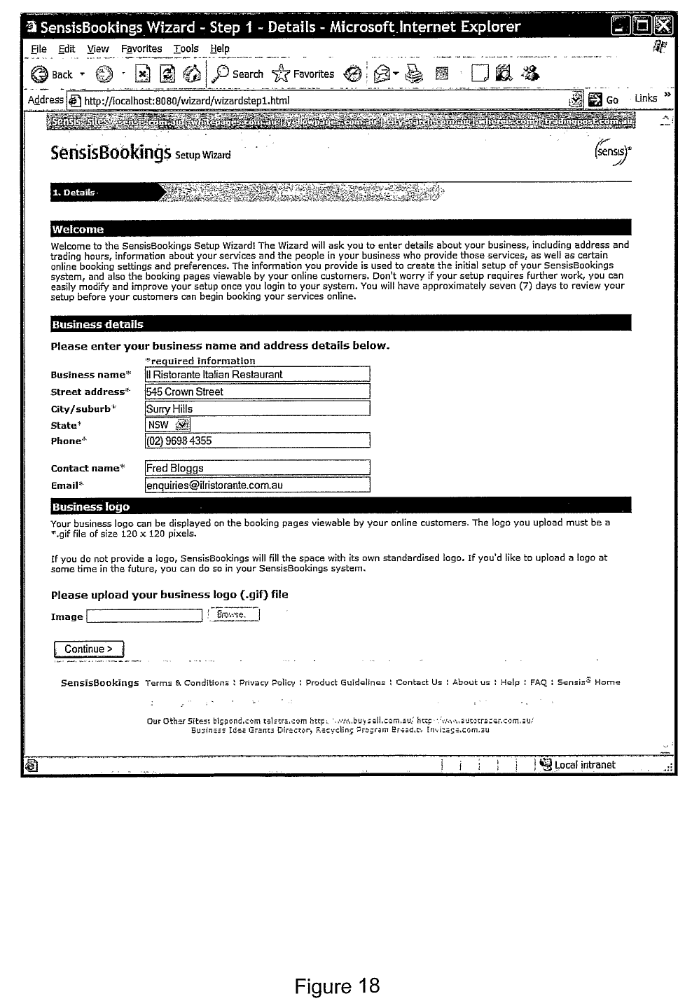

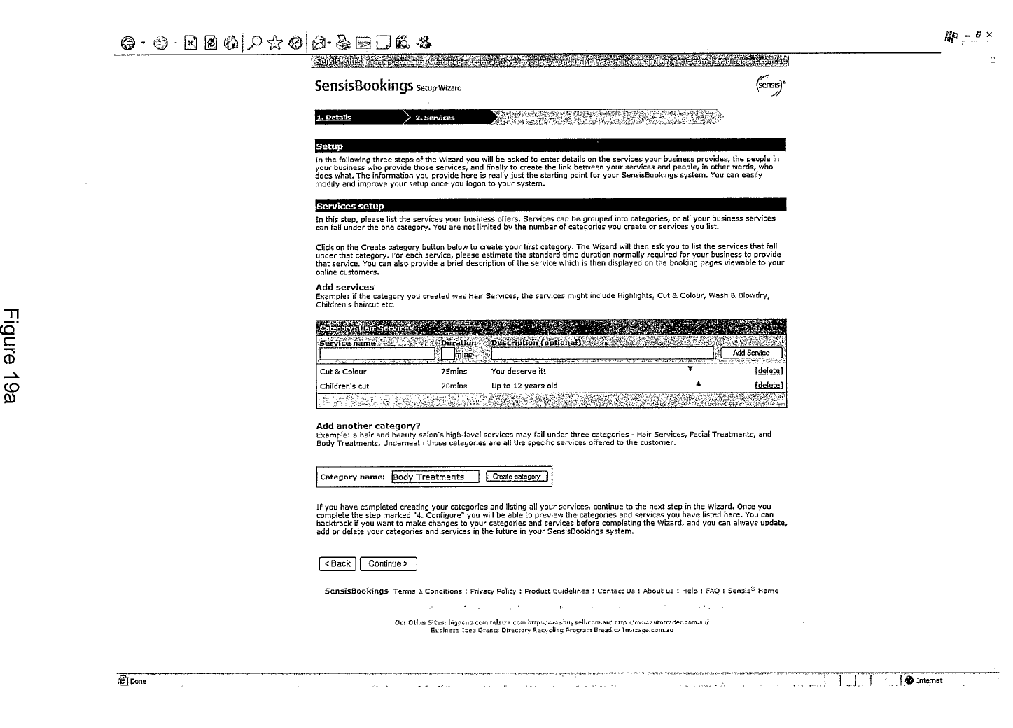

FIG. 18 shows essentially the same interface, which is populated in this sample with restaurant contact details. It would be appreciated that corresponding interfaces would be provided for accommodation providers. It can be seen that the overall look and feel of FIGS. 17 and 18 are consistent, however, the different service provider types may be provided with slightly different interfaces as is the case here, with the trading hours table omitted from FIG. 18.

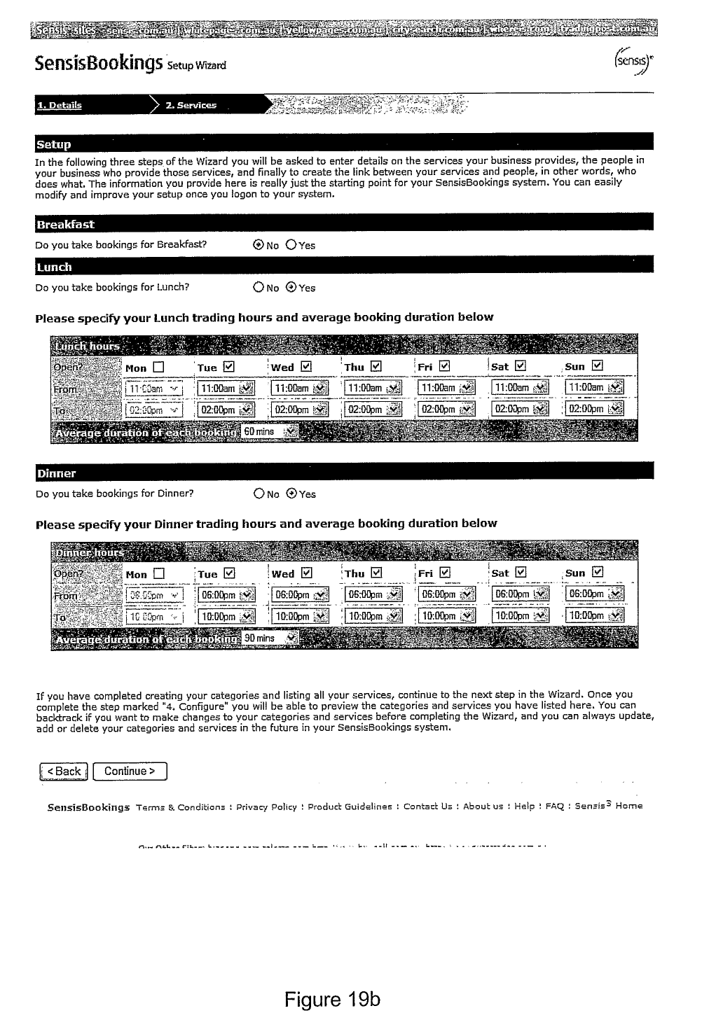

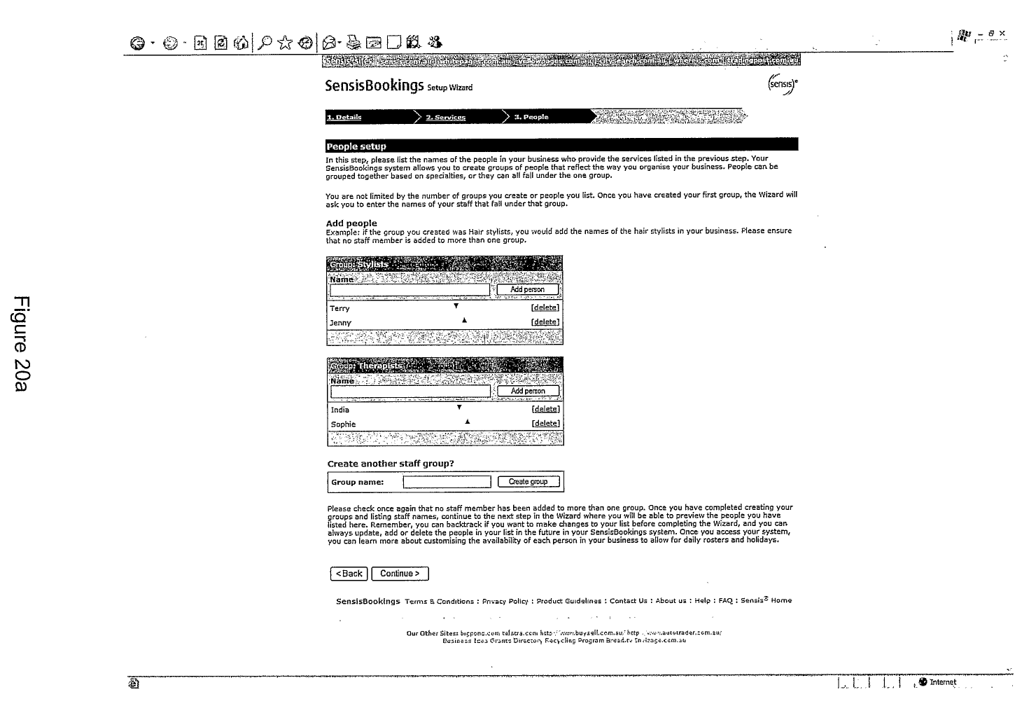

Referring to FIG. 19A the services interface 1900 allows the service provider to specify the title, duration and optional description of various types of a first service variable, by entering either the title field or each instance of the various types of the first service variable into the text field and (in the latter case) selecting the ‘add service’ button 1904. These service variables may be grouped under various categories added (or deleted) through filling out and selection of the create category 1920 button. In the sample in 19A the hairdresser of FIG. 17 is shown. In FIG. 19B, similarly a restaurant service provider can configure their services offered, including trading hours 1940, 1942 and average booking duration 1950, 1952 for each of lunch and dinner in the example shown.

In each of 19A, and 19B the display order of these various types of the first service variable may be changed through the selection of the up or down arrows next to the service provided 1906. The timeframe for the booking slot for the particular service provider may also be specified by filling out a text box 1908.

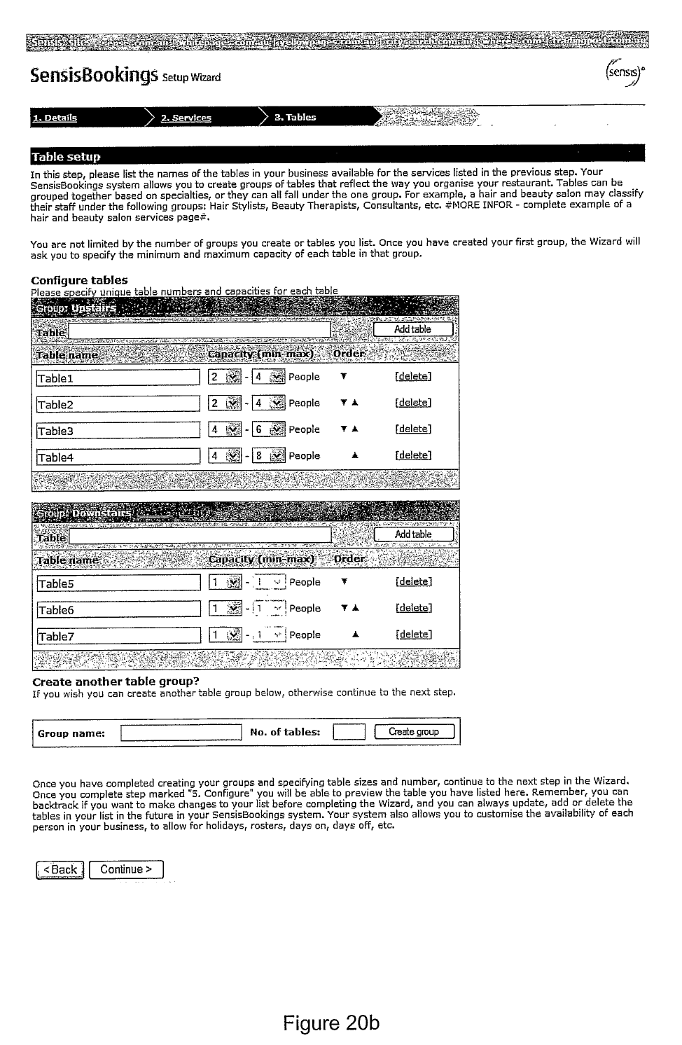

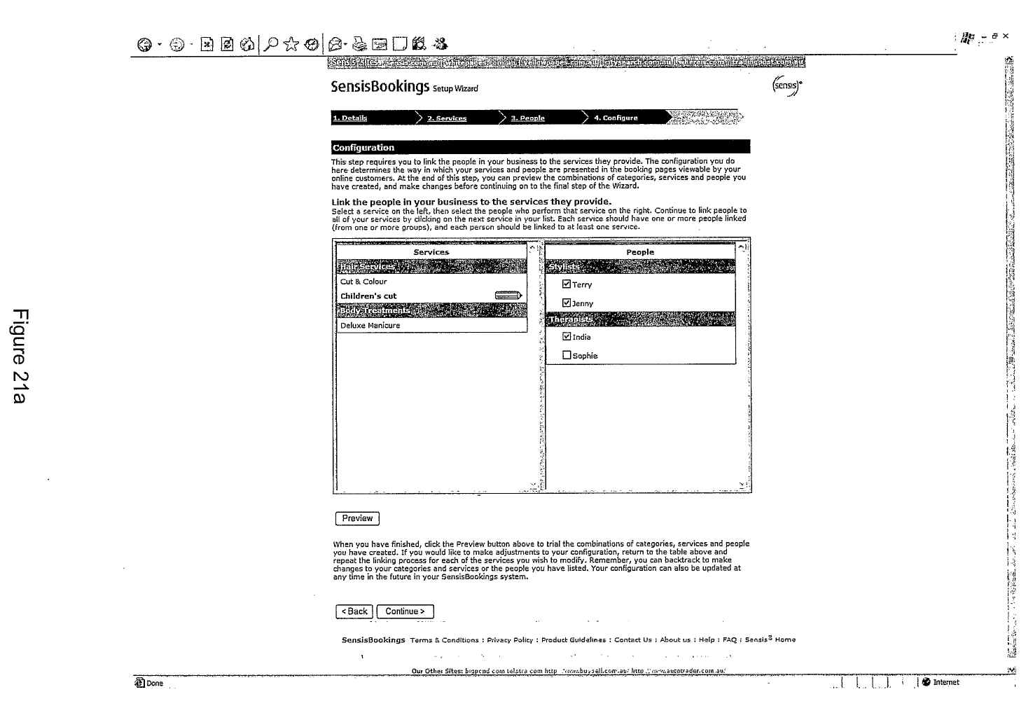

Selection of the continue button 1910 stores the information in a temporary data store, and presents the user with the resource interface in FIGS. 20A and 20B being the interfaces for the hairdresser and restaurant of FIGS. 19A and 19B respectively.

The resource interface 2000 of FIG. 20A allows the service provider to specify the title and groups of a second service variable in the hairdresser sample shown this is “People”. The service provider is able to enter each instance of the various personnel belonging to a particular group into the text field and then selecting the ‘add person’ button 2004. It can be seen that the title of the second service variable is “Stylist” 2006, with a number of stylist names included 2008. People may be allocated to a particular group, with groups being added through the use of the ‘create group’ button 2010.

Alternatively, FIG. 20B provides a quantity interface 2050 where the second service variable is determinative of the booking slot in combination with the first service variable, namely tables, with the number of tables being specified by the service provider using the add table button 2054. In this case the restaurant service provider is able to specify the number of tables of each type that exist and specify table groups, e.g. upstairs or downstairs with analogous ‘create group’ button 2060.

Again, the current context of the user is indicated by colouring of the relevant tab 2012 which appears in the breadcrumb trail across the top of the page. Similarly, selection of the continue button 2014 commits the information to a temporary data store, and loads the next page.

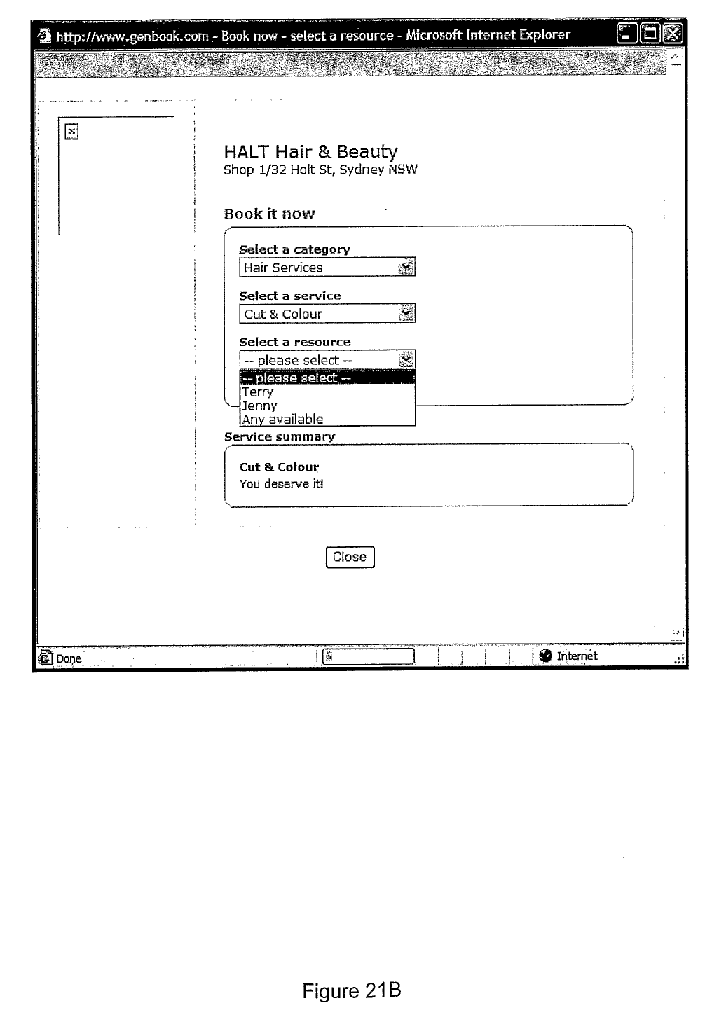

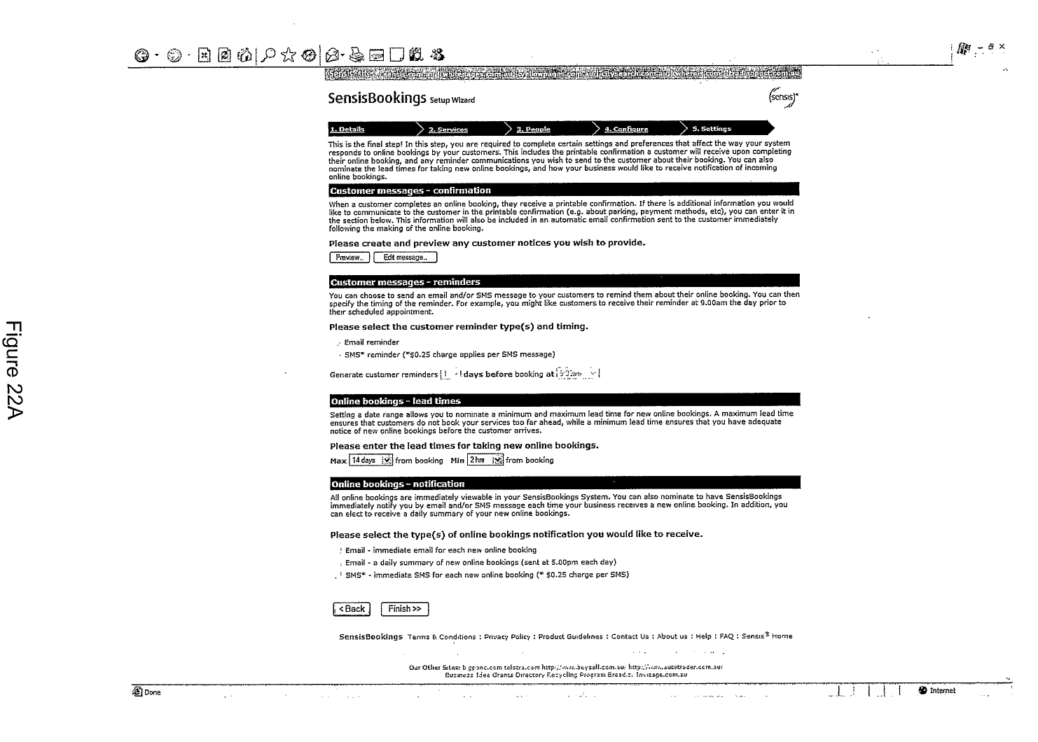

FIG. 21A shows a configuration interface 2100 which allows the service provider to associate the first variable with the second service provider variable, for example, by specifying who can perform a specific service category. In a case where personnel are specialised and only provide a limited service type—in this case ‘Body Treatment’ this will influence the availability of a service slot. In the case where the personnel can perform a full range of service types, the category type does not dictate the availability of the booking slot, but is merely descriptive of that slot. This distinction is important, and the implications will be discussed more in the subsequent discussion on the service provider configuration.

Once the service provider is happy with the associations between first and second variables, they may select the ‘preview’ button 2120 or the continue button 2130.

Now shown in 21B is a preview screen that is generated if preview is selected, which allows service providers to review the effect that their previously specified categories will have on the services provided.

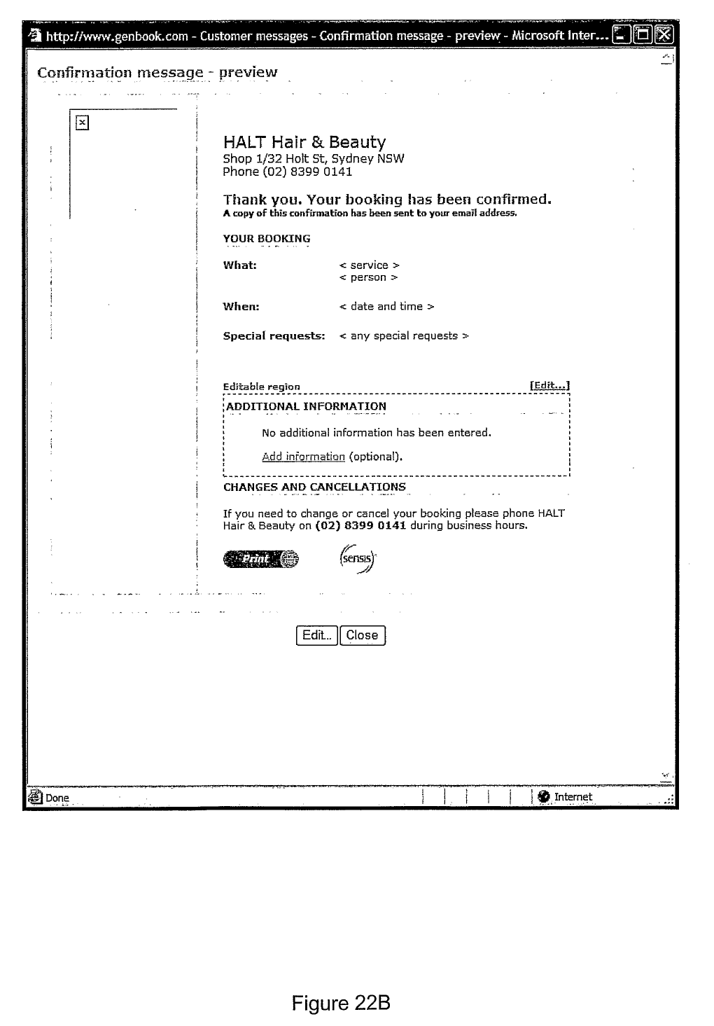

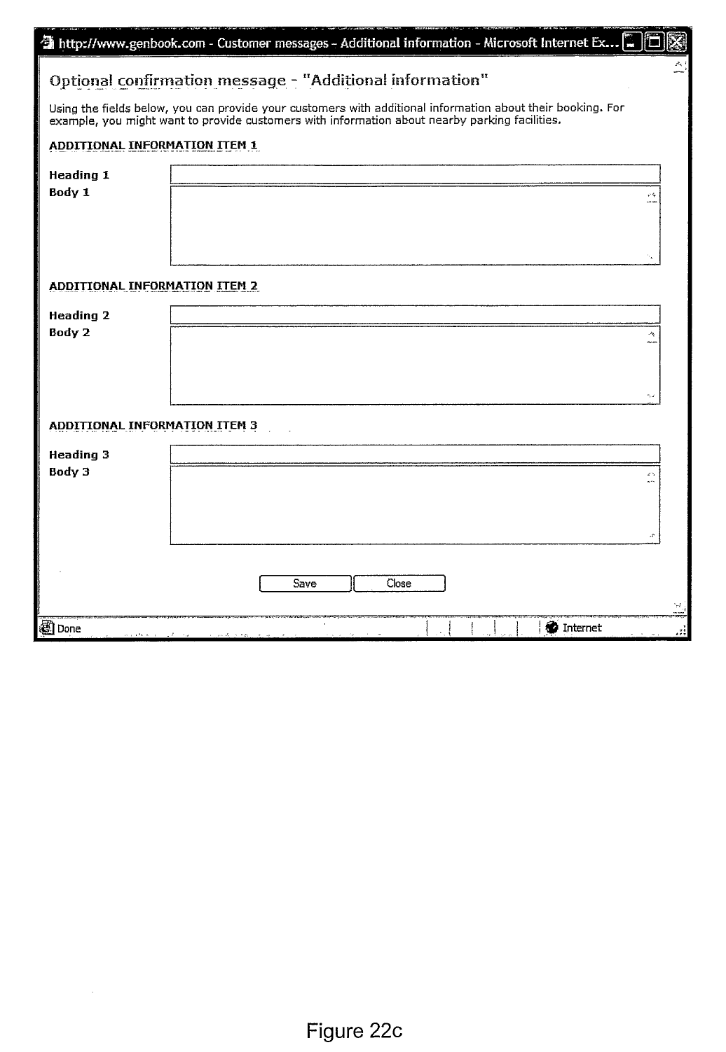

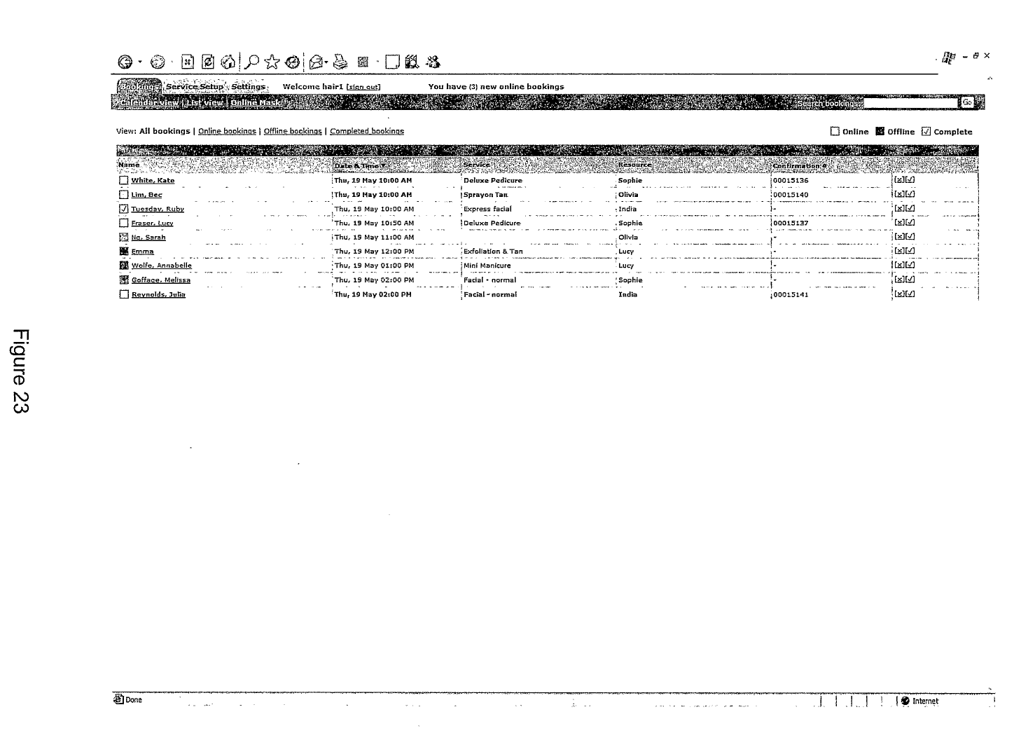

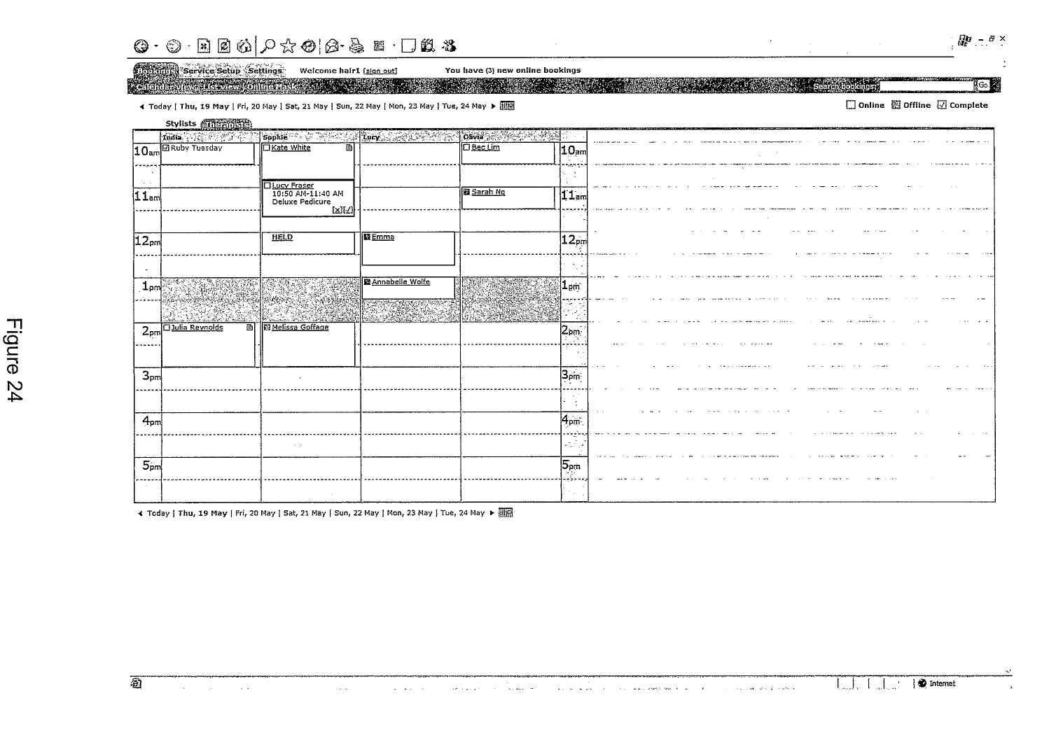

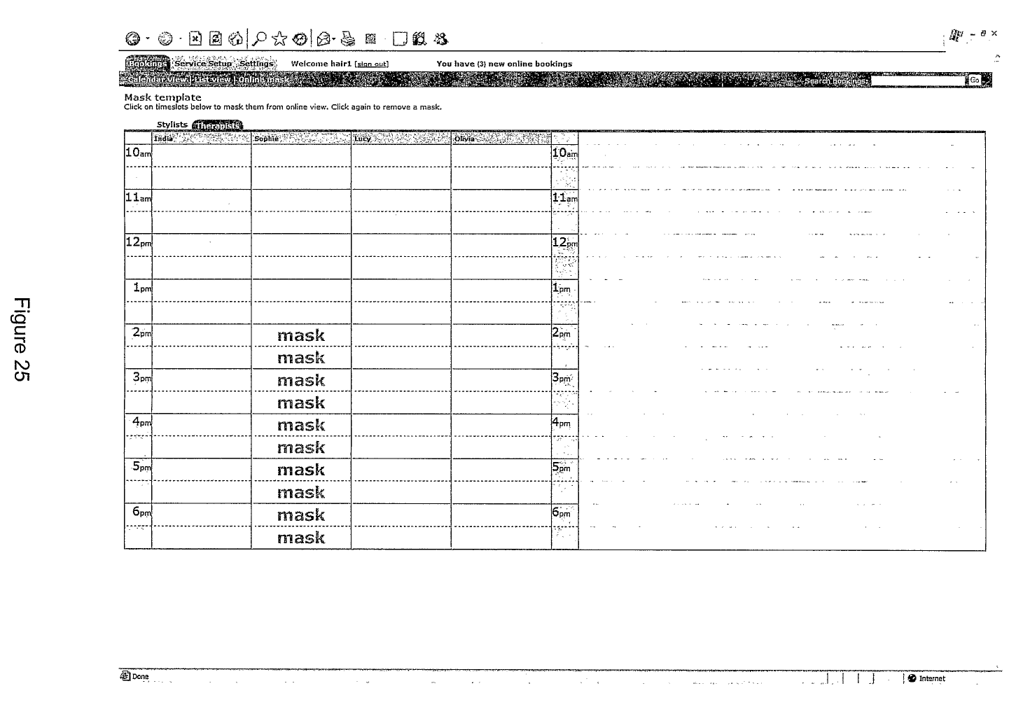

In the settings screens 2200 shown in FIG. 22A the service provider is able to specify the communication settings for customer messages including confirmation and reminders, including the timeframe and content of the messages that will be sent as well as additional information such as parking etc by using the edit message button 2206.

The service provider can also specify their minimum and maximum lead times, ensuring that service provider receives adequate notice, but is not booked too far in advance 2208.

The service provider can also specify the type of notification 2210 they wish to receive of an online booking, including whether or not they wish to be notified through SMS or email.

Selection of the Finish button 2202 on the settings screen commits the information from the temporary data store to the permanent data store, and presents the user with FIG. 22B. FIG. 22B may also be assessed using the preview button. The information appearing in FIG. 22B may be further customised through selection of the edit button, and by specifying additional information as shown in 22C. Finally, confirmation that the booking setup has been successfully completed may be provided to the service provider.

### Service Provider View:

Shown in FIGS. 23-29 are interfaces presented to service providers after they have logged on to a service provider administration page maintained for the booking engine by the search engine/directory listing provider. In accordance with usual access control procedures, access is granted only following successful users have been authenticated by providing their user identification and password.

It can be seen that four main tabs bookings, service setup, settings and availability are displayed to the service provider, representing a cluster of specific service provider interactions. These tabs allow the service provider or system administrator to specify the overall configuration of the online booking system that is presented to the user and are consistently retained in the same position, with the colour of the active tab changing in accordance with common principles in the art.

### Bookings

In FIG. 23, the bookings tab 2302 has been selected, in conjunction with the ‘list view bookings’ link 2304. A display 2306 which emulates a typical email client view is presented, and displays all new online bookings that have been received by the system since it was last accessed by the service provider. In accordance with the behaviour of typical email clients, once a booking has been reviewed by the service provider, this will be represented e.g. by ‘greying out’ or displaying in non bold the booking request. In the figure it can be seen that the bookings by Julia Reynolds, Kate White and Bec Lim 2308 have not been reviewed.

Turning to FIG. 24, in the alternative the service provider may select the ‘calendar view’ link 2406, which will present the interface 2400 shown in these figures. The service provider is then able to tailor the view displayed, by selecting from either of two variables provided as links 2404a, 2404b in the display, and corresponding to the group variables specified by the service provider when they initially configure the online booking system through the wizard described above. A legend 2408 is included across the top of the table in this example demonstrating visually the various states of a booking including online, offline and complete.

In FIG. 24 the statuses of various bookings against each time slot are displayed, along with a particular status in accordance with the legend. It can be seen that each stylist for the hairdresser in FIG. 24 can only perform one booking for a specific client per time slot.

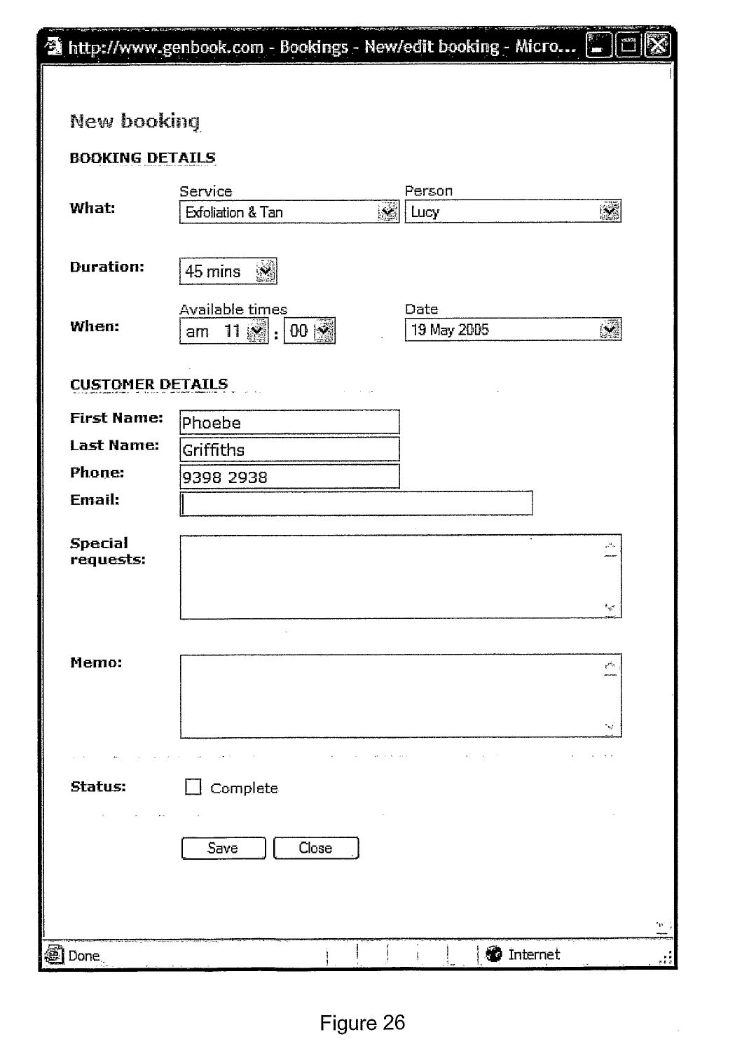

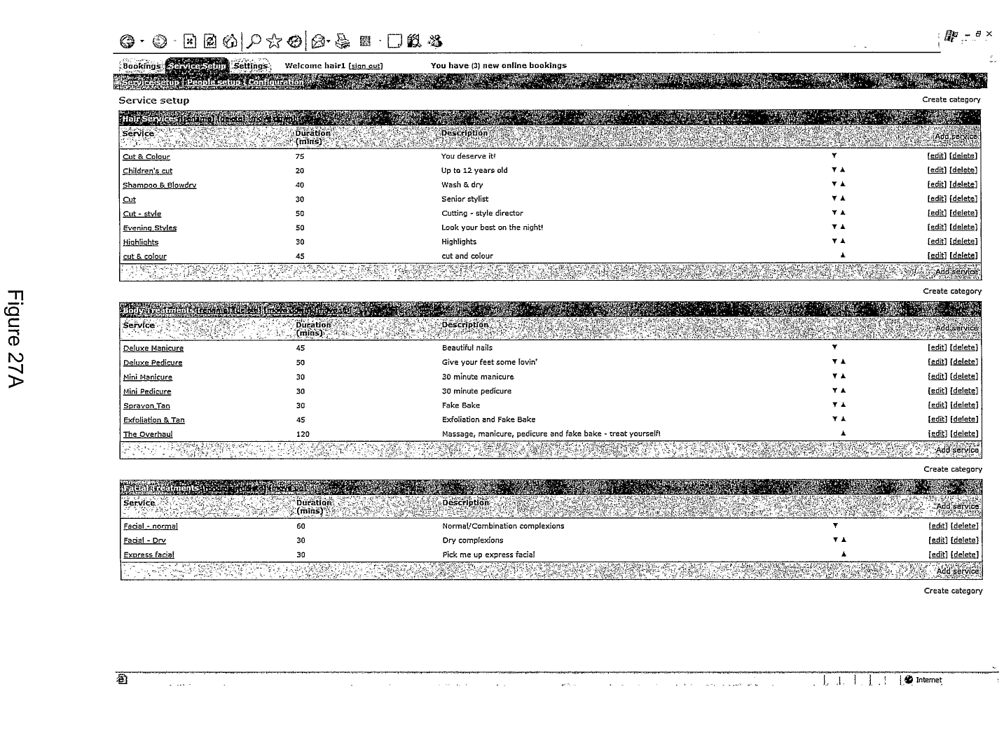

The facility is also provided on this view where the service provider can simply click on a particular timeslot and ‘hold it as is shown in the figure at 2410. Further, should the service provider wish to edit a particular booking they can do so at any stage, simply by selecting the booking, which will bring up in a child window the details shown in FIG. 26.

Should the service provider wish to permanently mask a particular timeslot, they may choose the “online mask” link which enables them to specify particular timeslots which will be universally masked. Shown in FIG. 25 is a view of an online mask screen, which enables service providers to specify particular time ranges of days which they do not wish to make available to be booked online. The service provider is able to activate or deactivate a mask timeslot by timeslot simply by selecting or unselecting a timeslot as required by “clicking” with their mouse on the relevant timeslot. In FIG. 25 shown, Sophie, a stylist does not take any online bookings after 2 pm 2420.

This ensures that services providers can easily manage their inventory of available times for online booking, and that competitors accessing the online booking system are not able to gain an unhindered insight into the activities and operations of the service provider.

In each of FIGS. 23 and 24 selection of a particular booking by clicking on the status brings up a child window allowing the service provider to edit the booking status or client details (see FIG. 26). Editing may occur in response to a telephone enquiry or to reflect someone entering from the street and occupying a table in the restaurant example demonstrated. As is clear from FIG. 24, where the existing booking system of a hairdresser is not fully integrated with the online booking system of the invention, bookings made from other sources such as phone bookings may be effectively migrated over to update the system merely by indicating a HELD or masked slot rather than providing the full booking details. The same principle would apply in the case of a restaurant, where a table could be indicated as simply being booked or unavailable

### Service Setup Tab

One aspect of the present invention lies in modelling certain service provider types as combinations of at least two variables.

These variables may together specify a unique booking ‘slot’ in conjunction with a particular time and date. For example in a restaurant, the number of people at a table and their dining location in conjunction with the time and date both together uniquely define a booking. (Of course, multiple instances of a particular combination may be available at a specific time and date, although each table would have a unique table number which represents a unique bookable entity. Hence, there may be three tables of two in the downstairs dining area.)

Alternatively, one variable may be sufficient to specify the booking ‘slot’ in conjunction with the booking time and date. The other variable in this case is merely descriptive, rather than being determinative of the booking slot. For example, in the case of a hairdresser, a particular hairdresser can only be booked for a particular time on a particular day, but may carry out a multiplicity of services—e.g. male hair cut, female hair cut, tinting etc. In this case, in conjunction with the time and date, the variable determinative of the booking slot is the person conducting the service, rather than the service carried out, which may be useful merely for the information of the service provider. Similarly, a particular doctor may perform only one consultation in a particular time and date, but this consultation may be of a number of types, such as standard or initial.

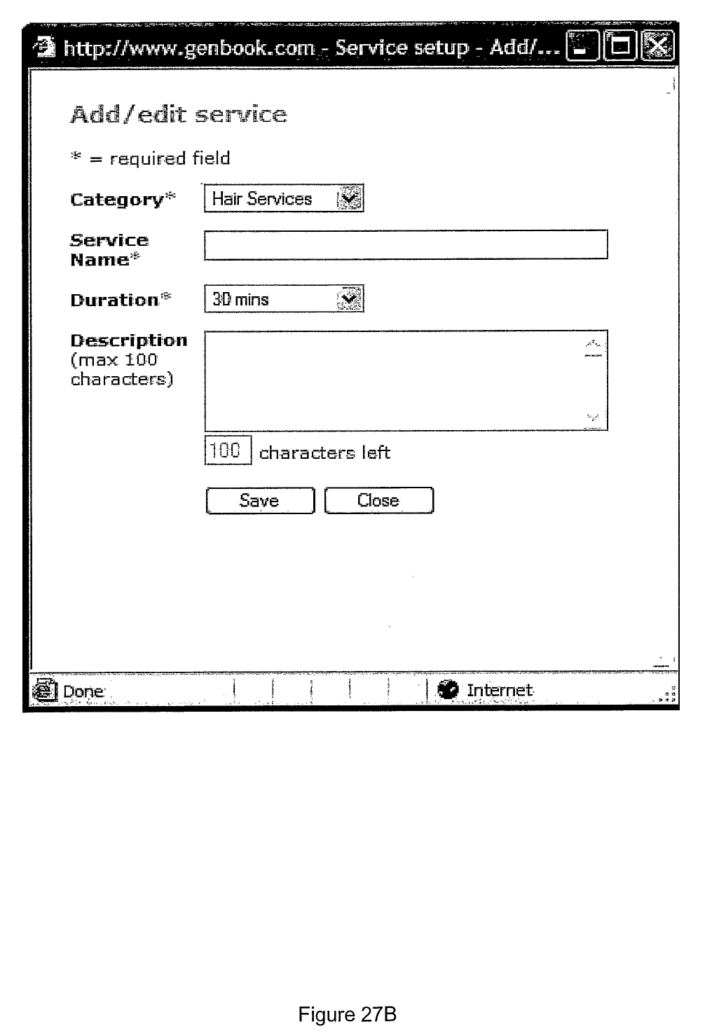

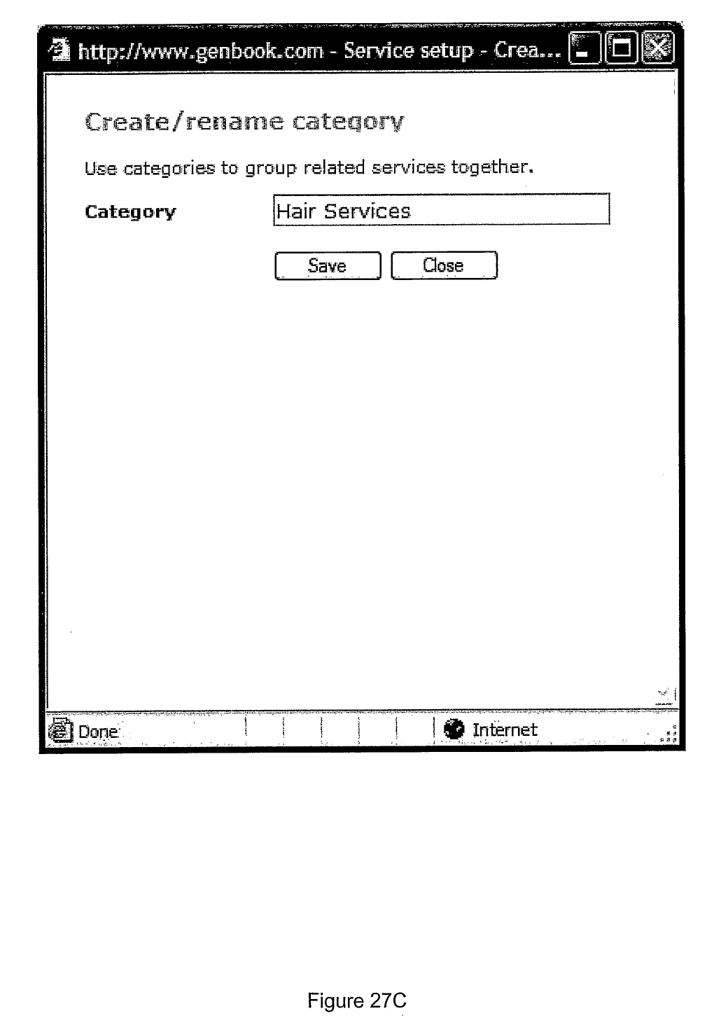

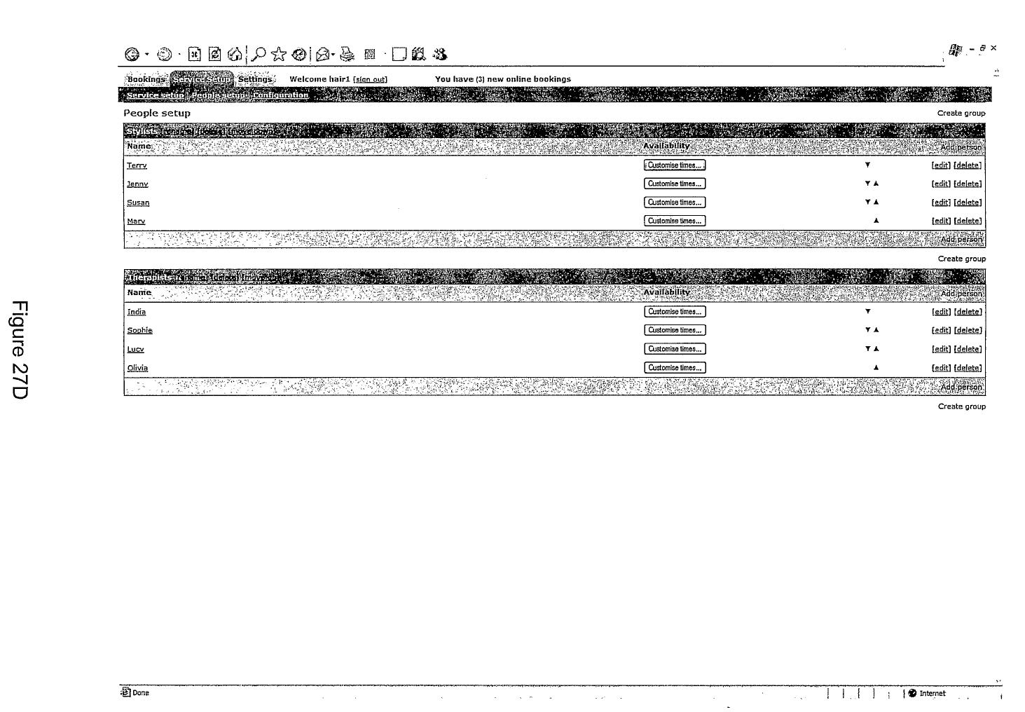

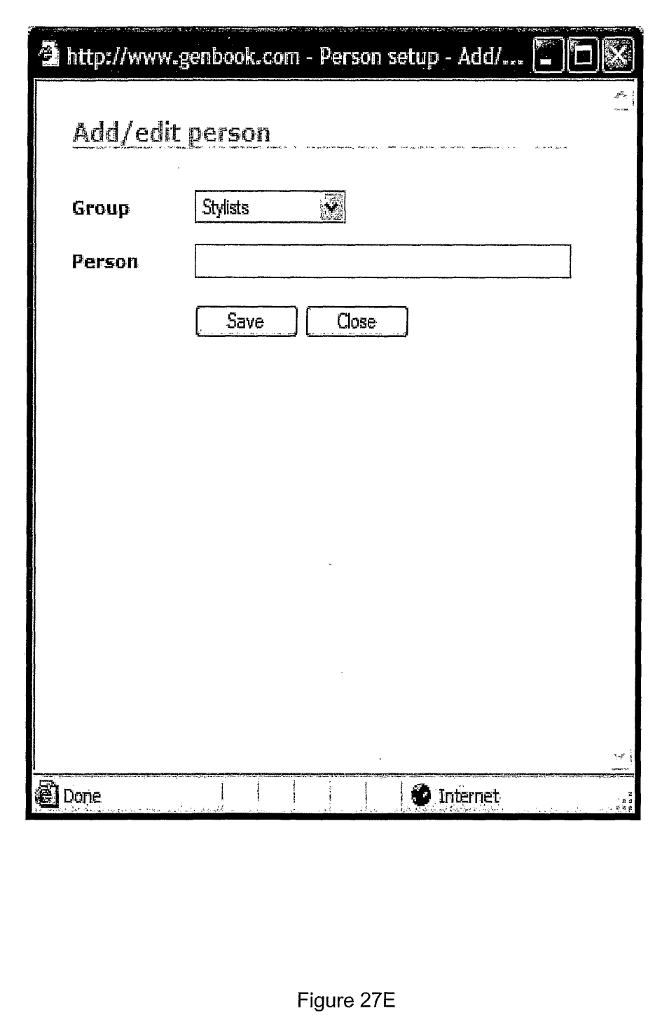

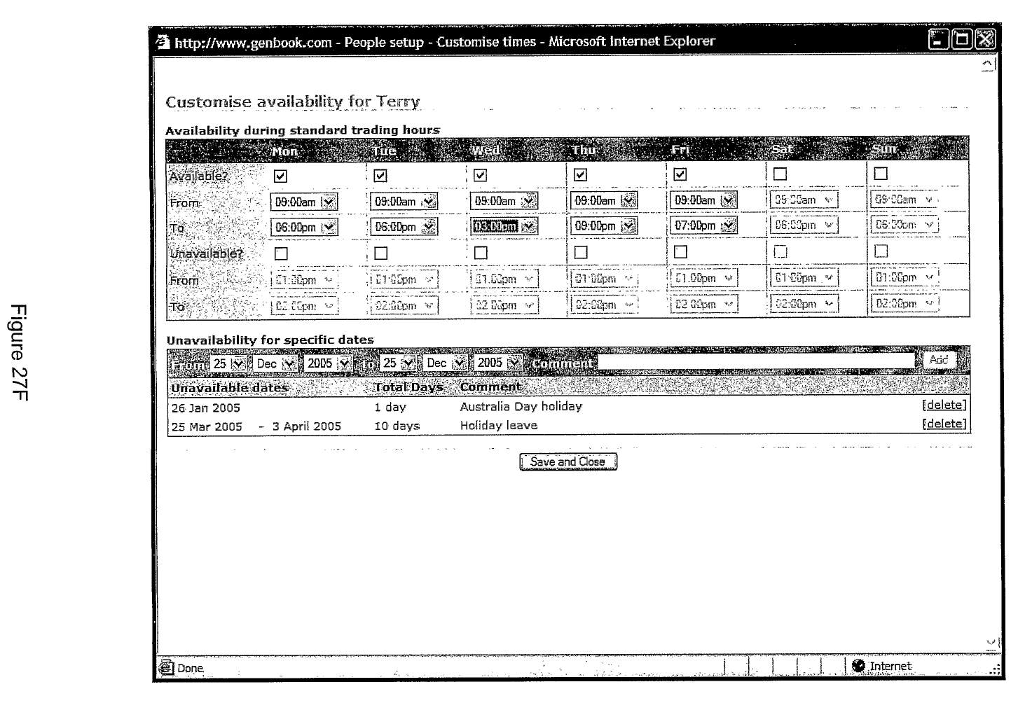

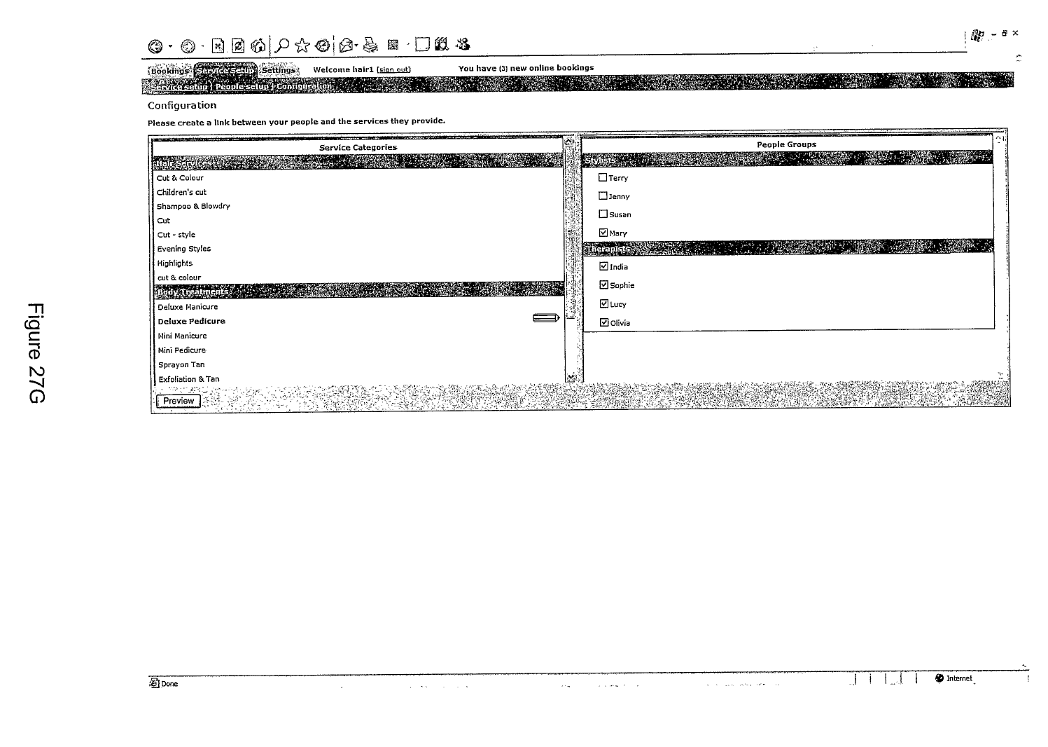

Once the service setup tab has been selected, an interface 2700 is displayed. In FIG. 27A the service provider is then able to select a link 2702 to configure the service setup, people setup or configuration.

As shown in FIG. 27A, the link for the service setup is selected. Further selection of the create category tab generates a child ‘popup’ window 27B, in which the service category may be added or edited. Shown in 27A at 2706,2708 and 2710 are Hair Services, Body Treatments and Facial Treatments respectively. Particular options associated with each of these categories may be specified, as set out in 2720 for Hair Services. These categories are drawn from those specified through the use of the interface of FIG. 27B. Should it be necessary, selection of a corresponding edit tab against a particular option generates a child popup window FIG. 27C, which allows a service provider to add/edit service offering, including specifying the description and duration of the service offered.

Selection of the People Setup link of FIG. 27A presents the service setup interface, shown in FIG. 27D which allows the service provider to customise the availability and identification of the resources available. Selection of the rename link 2720 allows a group to be created or renamed (see FIG. 27E). Alternately, it may be necessary to add a person to a particular group, which is readily achieved through the selection of the edit/delete link, which generates the child popup window FIG. 27E.

Selection of the customise times button 2730 in FIG. 27C generates a child window 27F which allows the availability of a particular person to be customised. This allows a service provider to include holiday dates, and leave in the booking system. The standard hours previously specified in FIG. 17 and stored would be propagated through to the interface, to facilitate rapid customisation of the availability of each resource.

Finally, if the configuration link is selected from FIG. 27A, the service categories may be associated with particular people groups as shown in FIG. 27G. For example, selection of the Deluxe Pedicure category 2770 allows the service provider to specify which resource is able to carry out the service 2772.

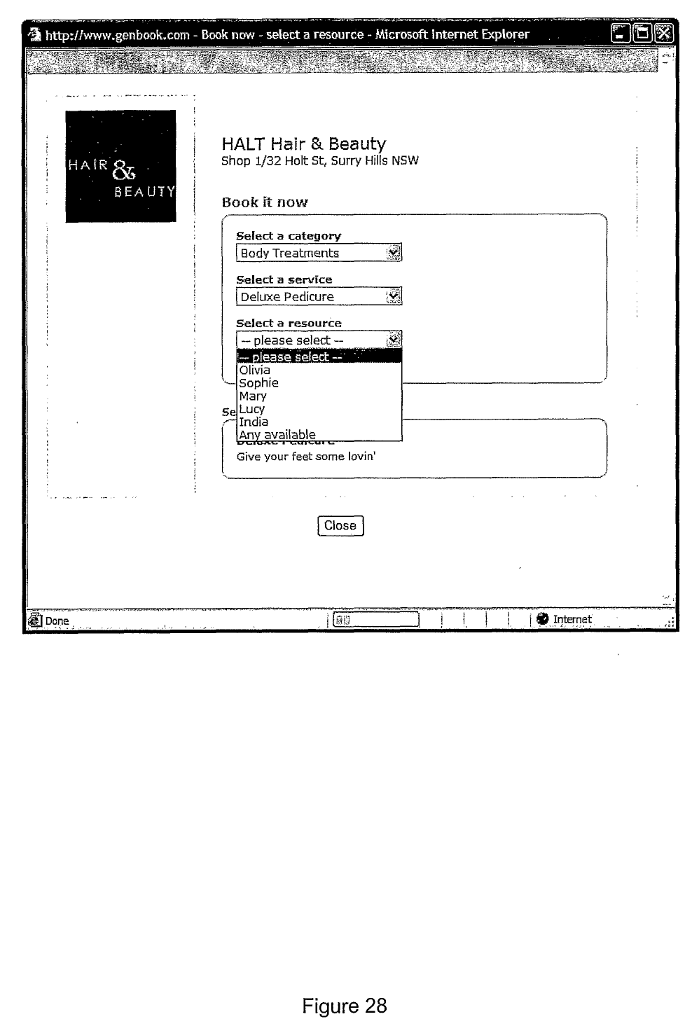

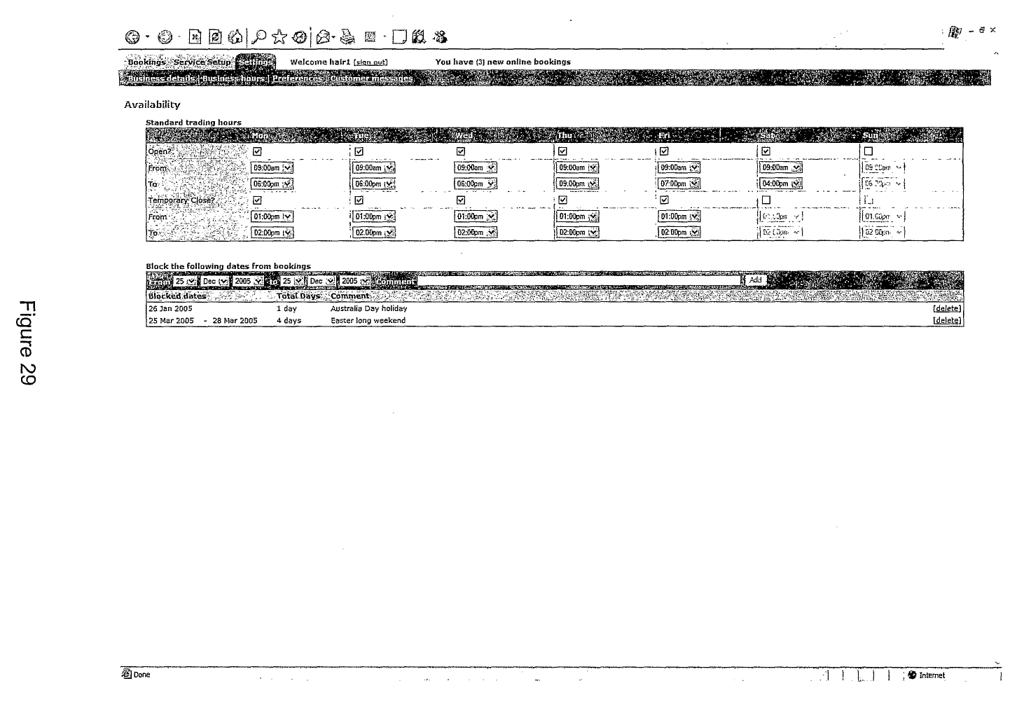

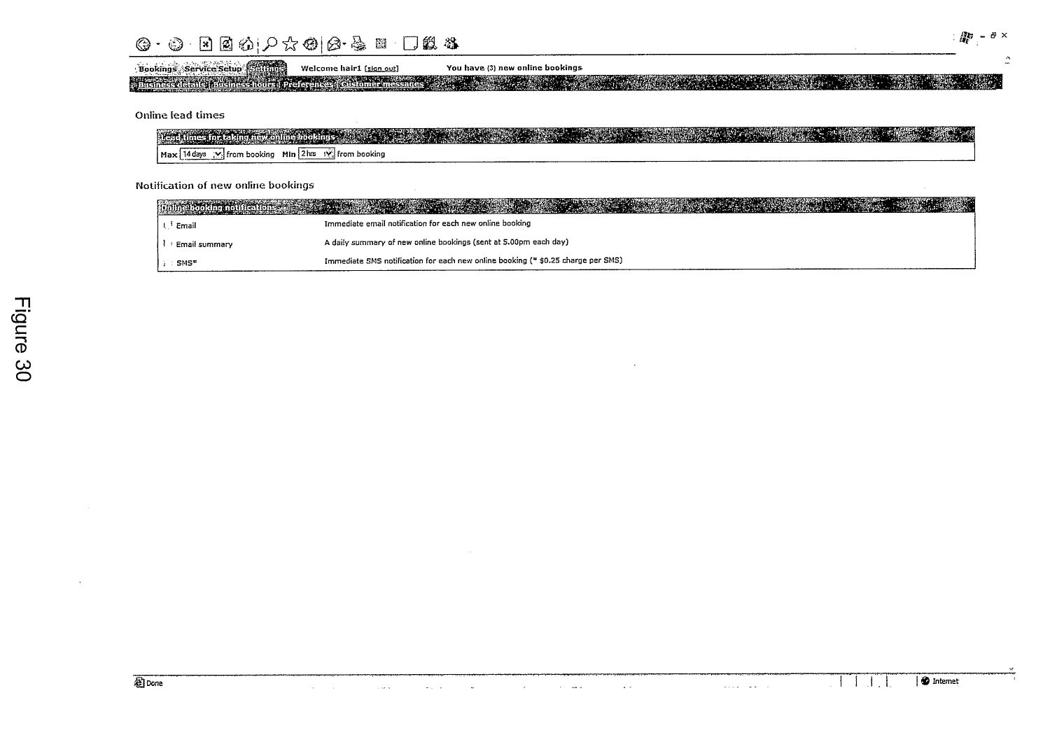

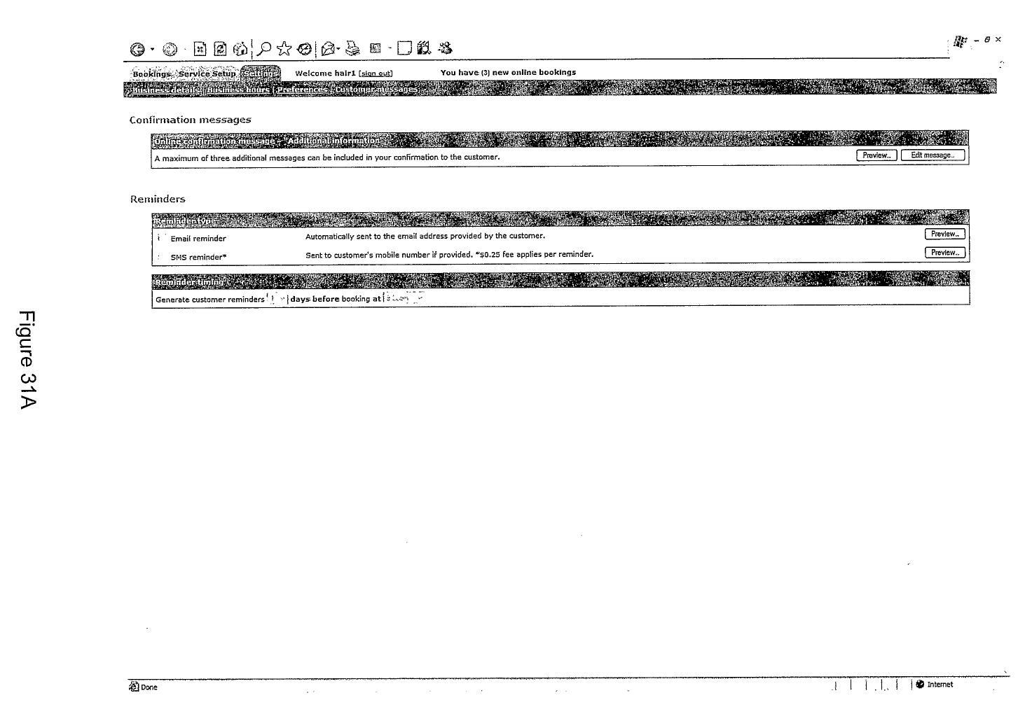

So that the details specified may be checked, the preview button 2760 may be selected, and a preview of the interface that would be seen by the user of the system is generated (FIG. 28), in which the various categories, service types and resources are visible.

### Business Hours

Selection of the “business hours” link generates a default settings subform, FIG. 29 which shows the settings for the hairdresser service providers. This screen allows the service provider to specify how they wish to manage their bookings, including standard trading hours 2902, non trading hours 2904, non trading days 2906.

### Preferences

FIG. 30 is a sample interface 3000 displayed once the preferences link 3001 on the settings tab has been selected. This link allows the service provider to specify the minimum and maximum lead times allowed for new bookings, including the capacity to specify the mechanism by which the service provider is to be notified of new online bookings.

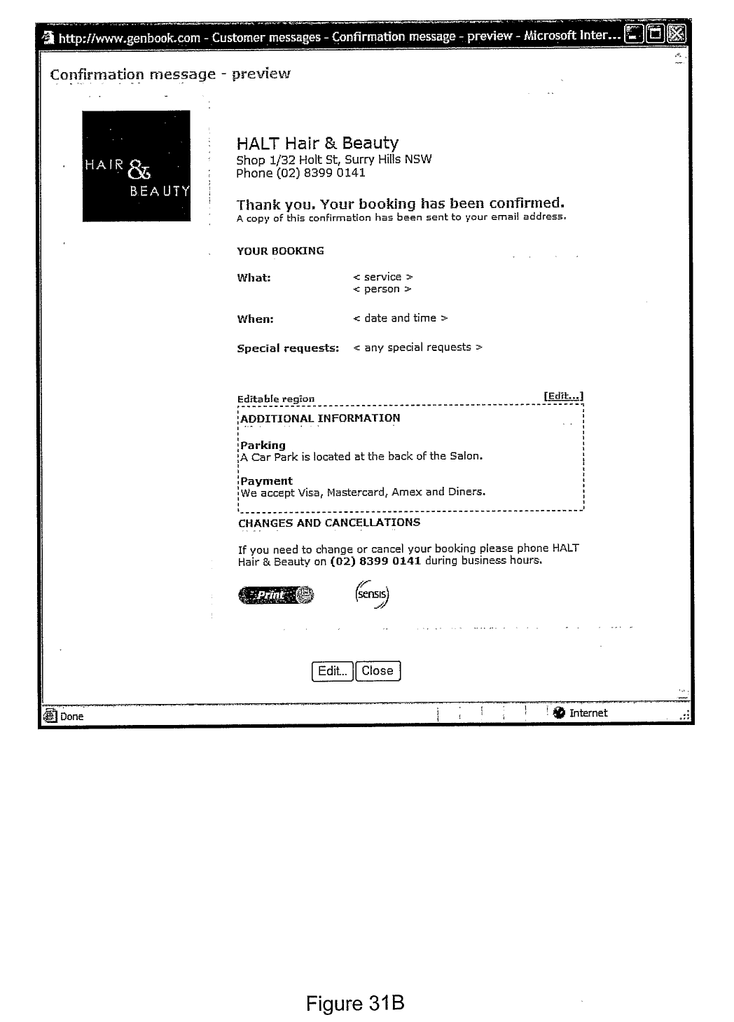

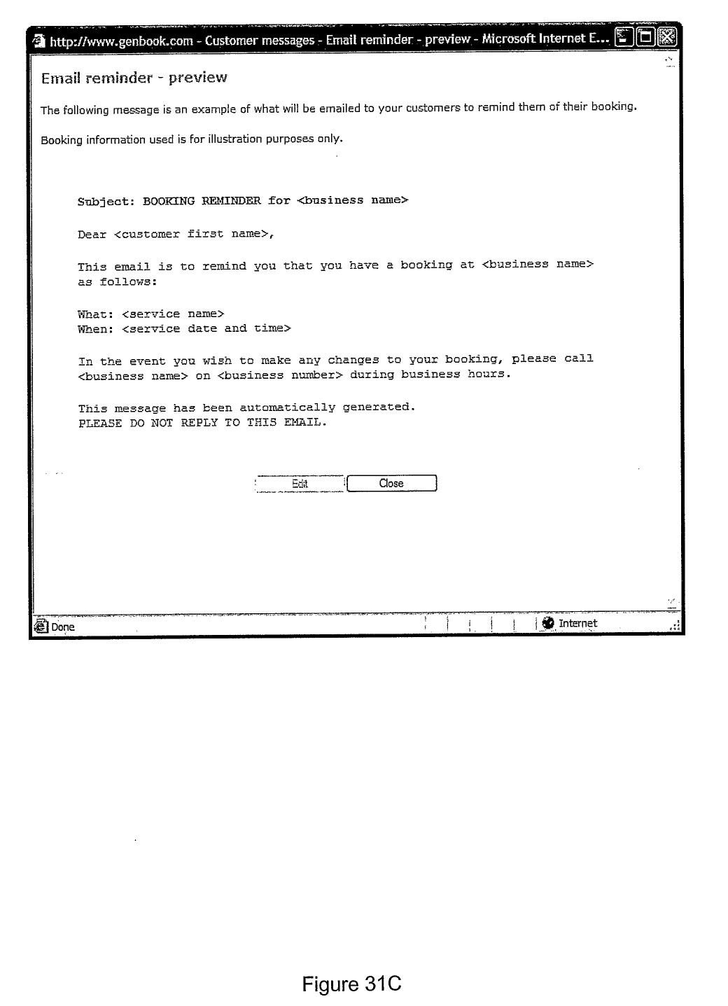

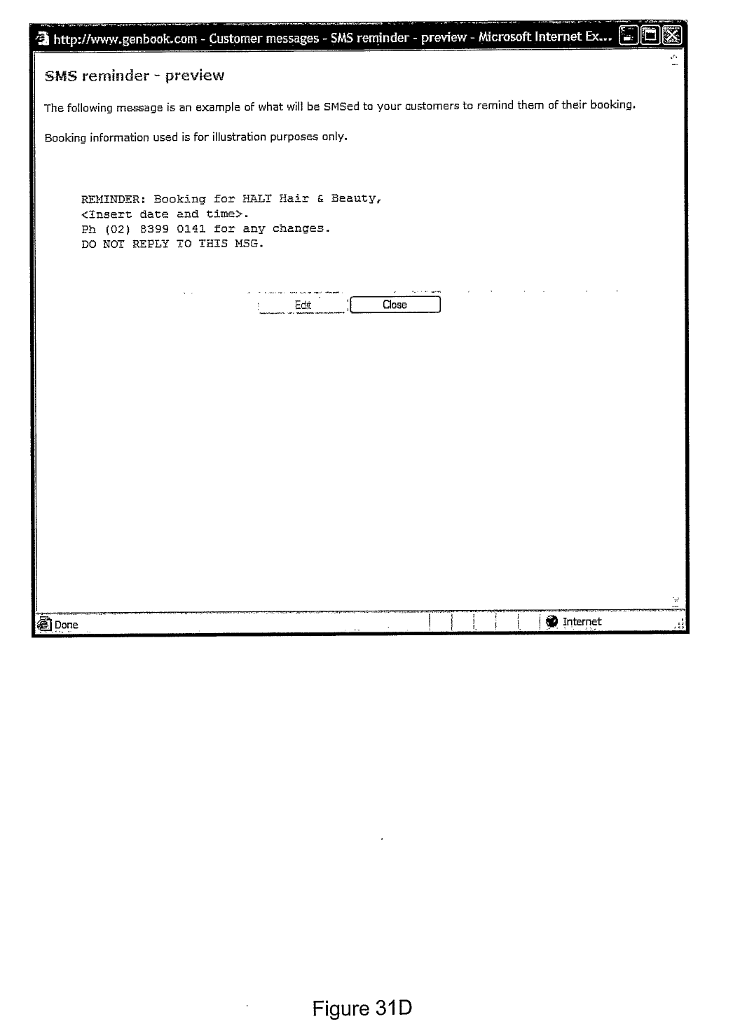

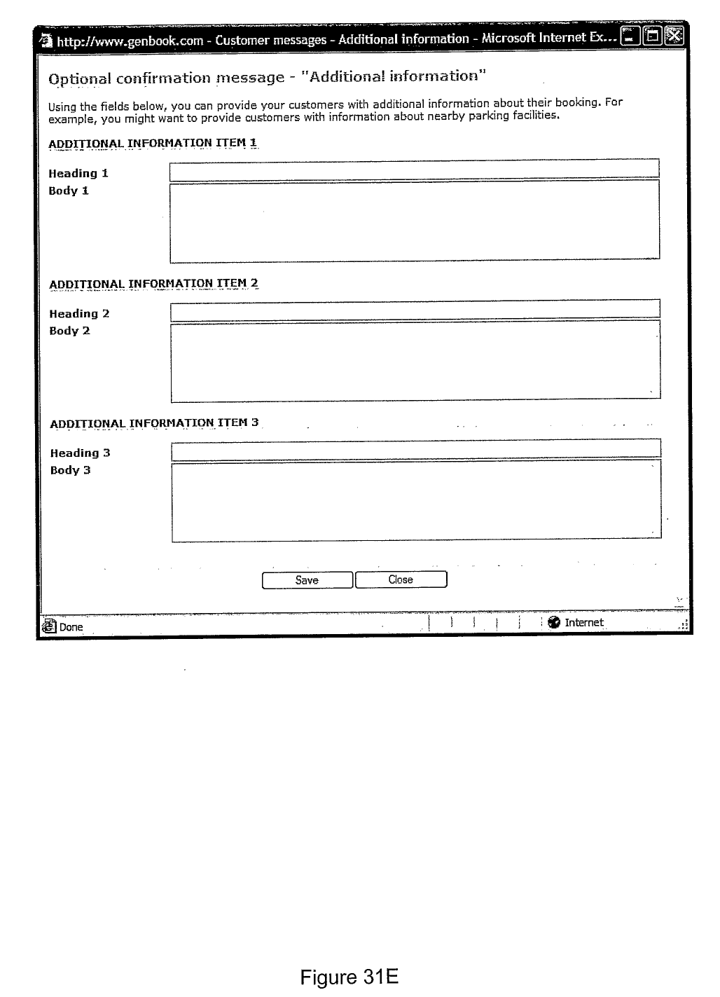

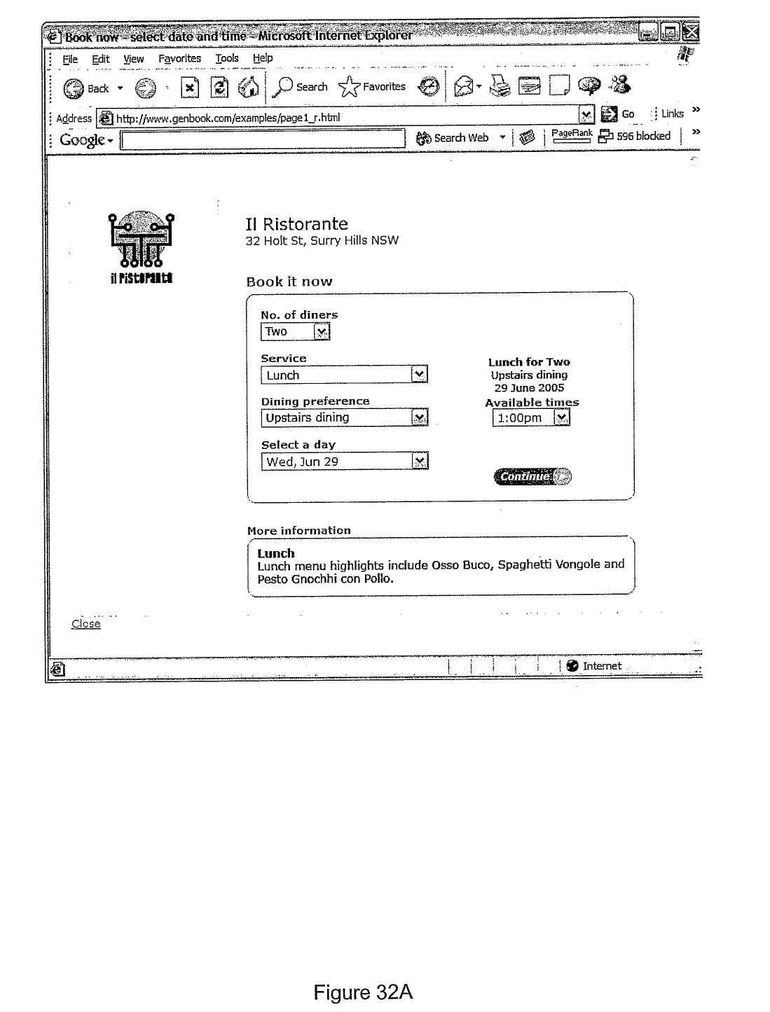

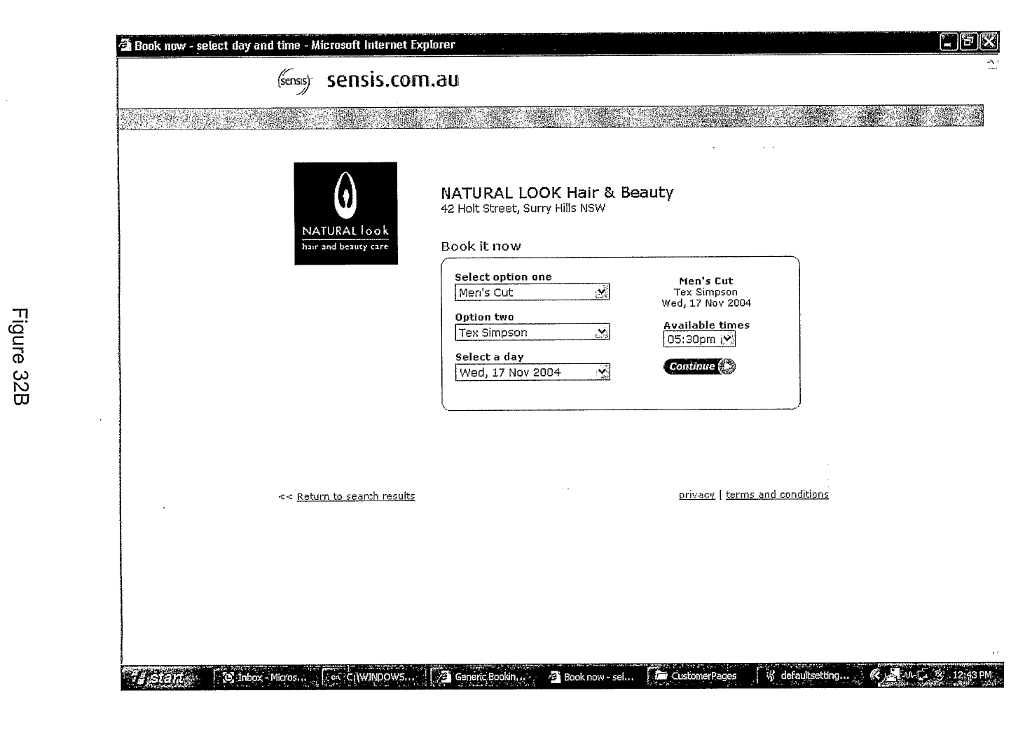

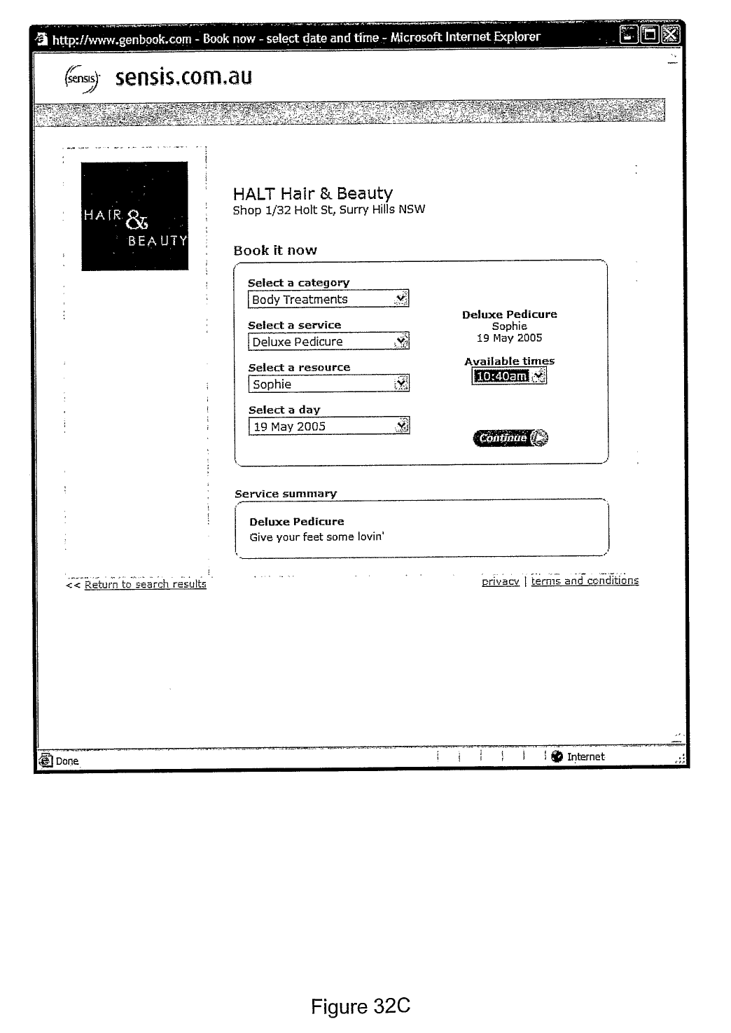

FIG. 31 A shows the sub form 3100 generated once the customer messages link on the settings tab has been selected. Form 3100 allows the service provider to specify the form and timing for which confirmation and reminder messages are sent to the customer.

Selection of the preview button 3102, 3104, 3106 allows previewing of the confirmation, email reminder and SMS reminder that will be received by the customer. These are shown in FIGS. 31B-D respectively. Shown in FIG. 31E is a further sub form accessible from the form FIG. 31B through selection of the edit button, which shows the mechanism by which the additional information presented to customers may be edited for display.

### Customer View

When a customer interacts with the booking system irrespective of the nature of the service provider, the customer is provided with a generally similar booking process, with the same steps and similar process flow.

FIGS. 32A and 32B and 32C show the view presented to a customer, after they have selected a booking link from the list of qualifying service providers that has been returned by a search engine or directory listing. An example link is shown in FIG. 4 or FIG. 5. It can be seen that the customer is presented with a generally similar interface, wherein they are able to specify two particular options. In FIG. 32A these options are the number of diners and the type of dining required. In FIG. 32B the selection is from the type of service required and the stylist name. In FIG. 32C, the customer can specify the category, service and resource for a service provider beautician and the configured description may appear in the service summary area shown. Depending on the combination selected the available timeslot is dynamically updated to reflect only the available times. The description provided by the Service Provider may appear in the service summary area shown.

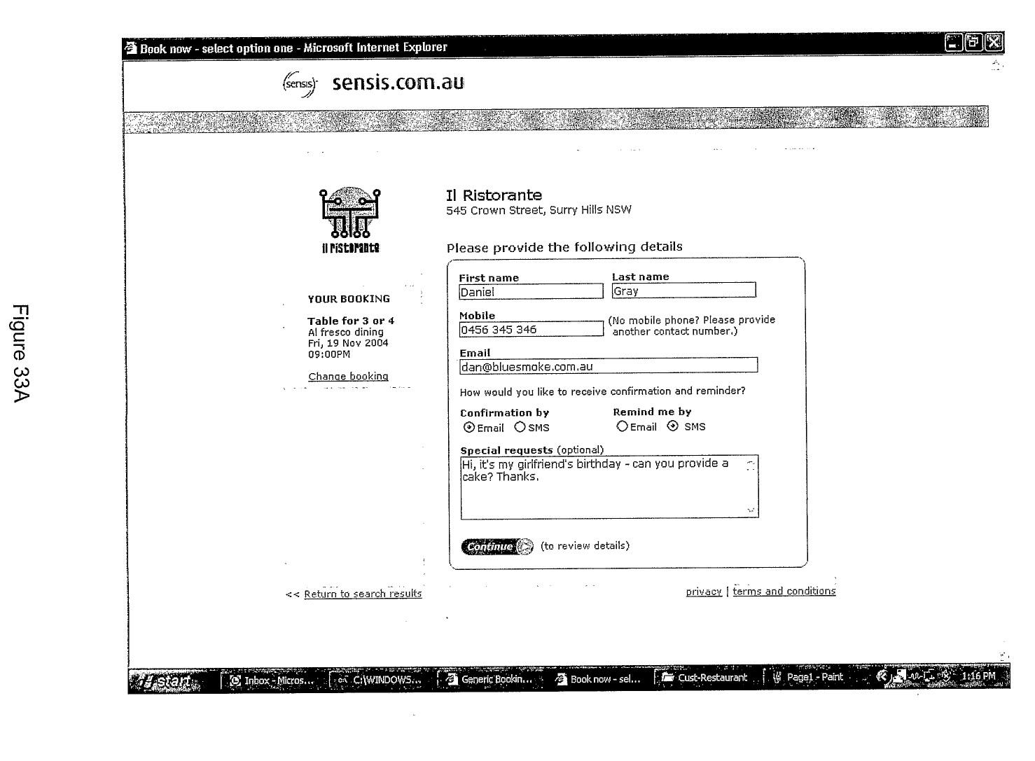

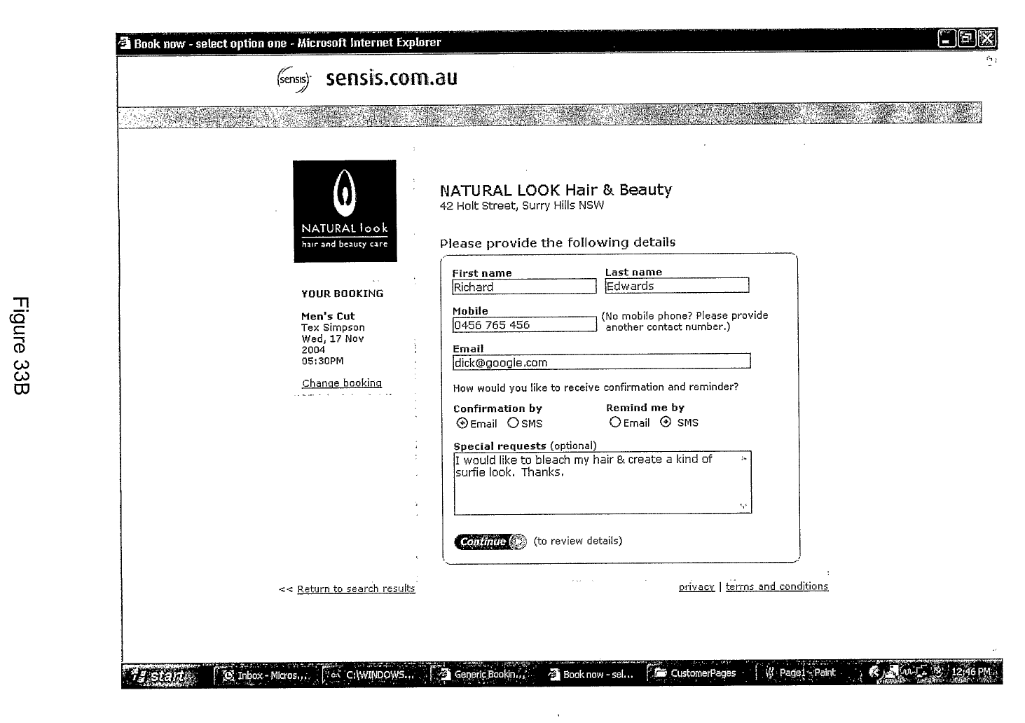

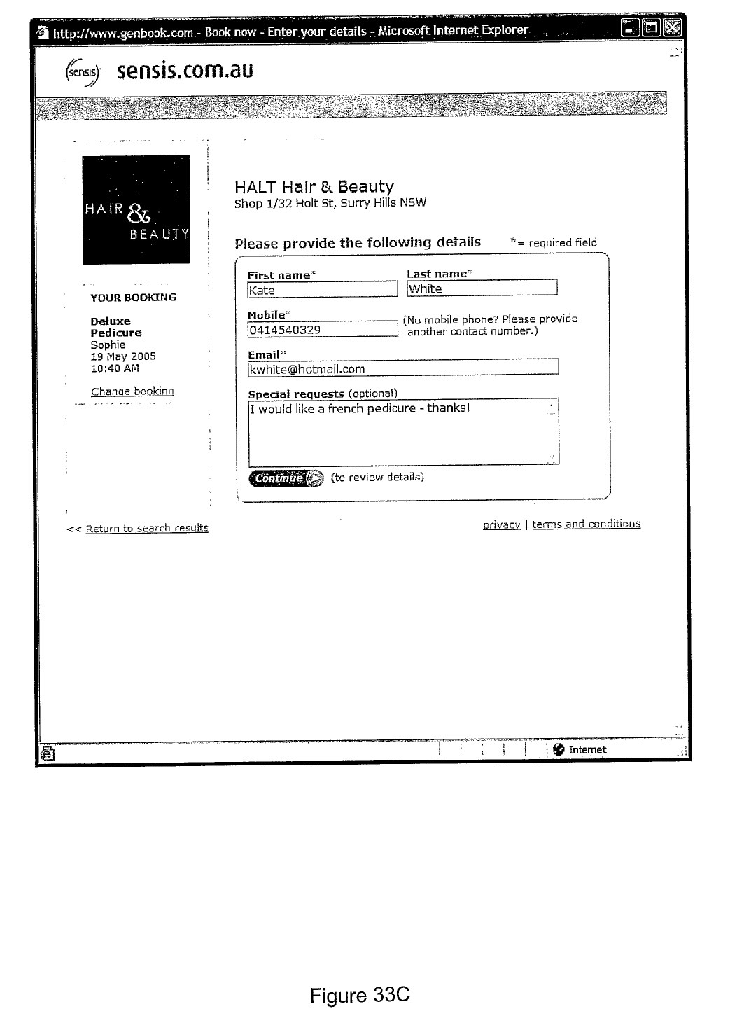

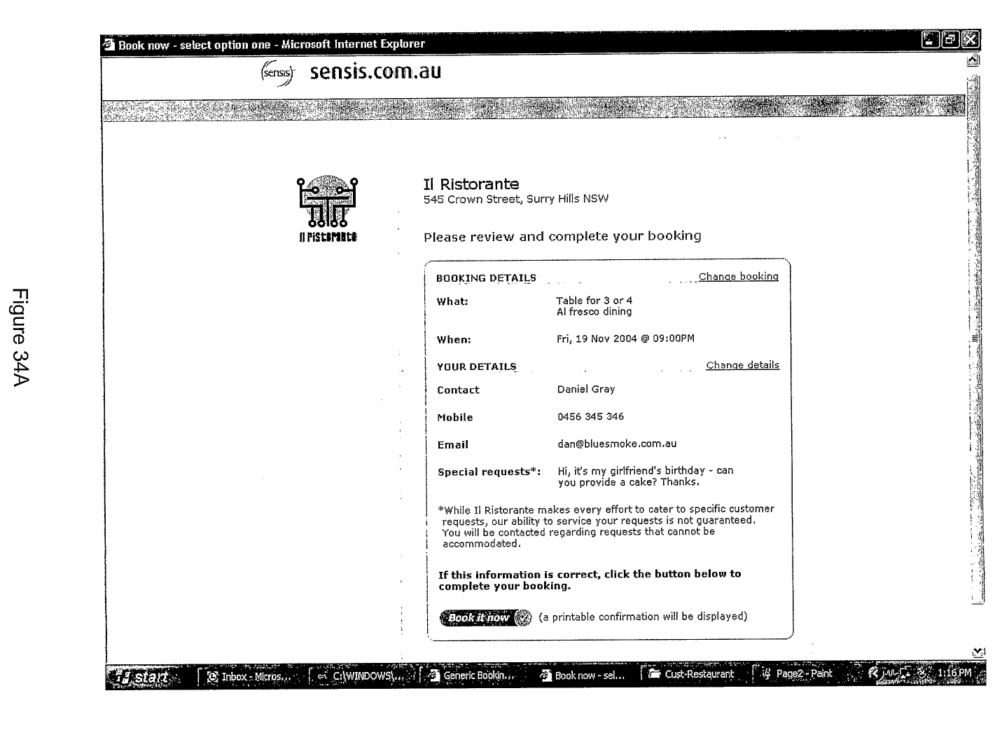

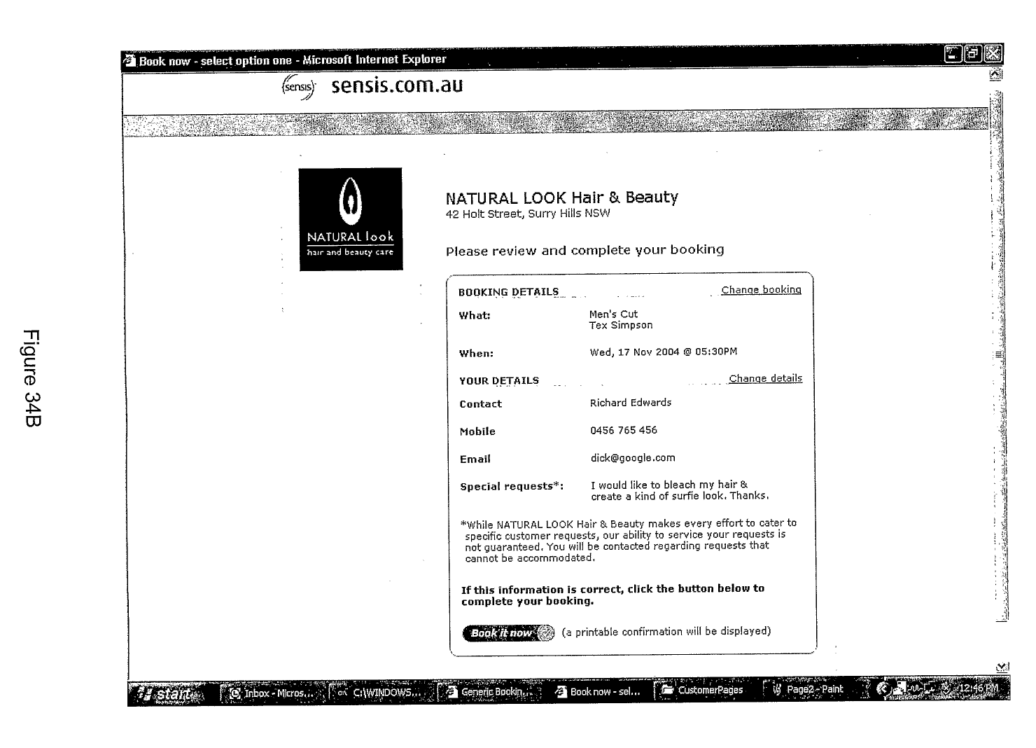

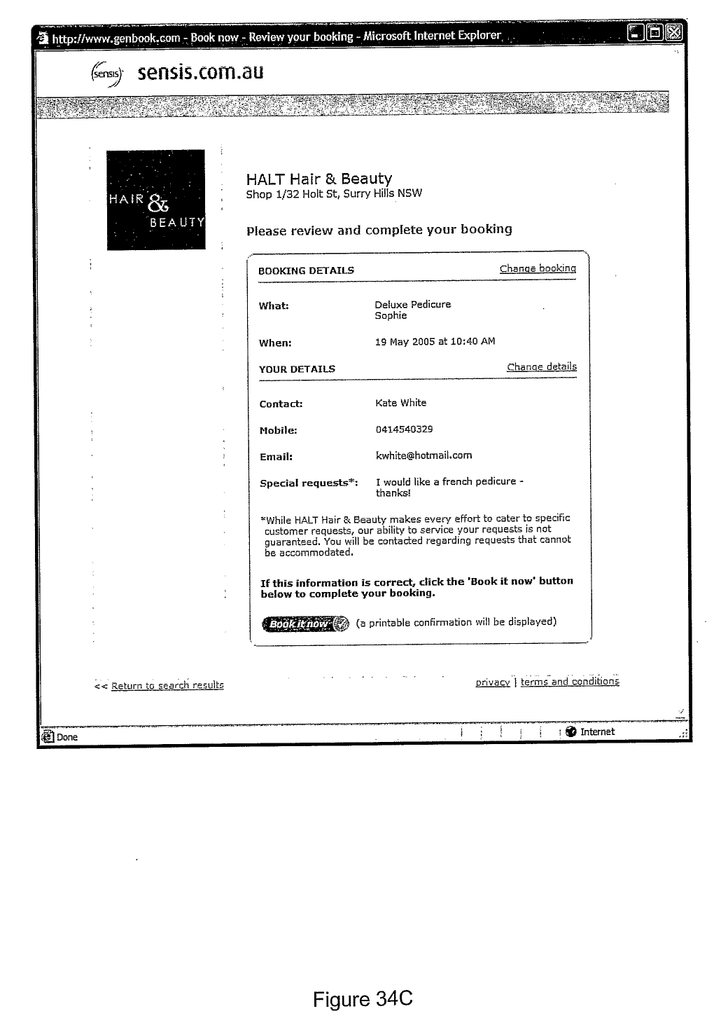

After selection of the continue button, the customer is presented with the second booking interface shown in FIGS. 33A, B and C. At this stage the customer enters standard contact information into text fields. After filling out the form, the customer is presented with the review page shown in FIGS. 34A, B and C which allows the customer to review their selections.

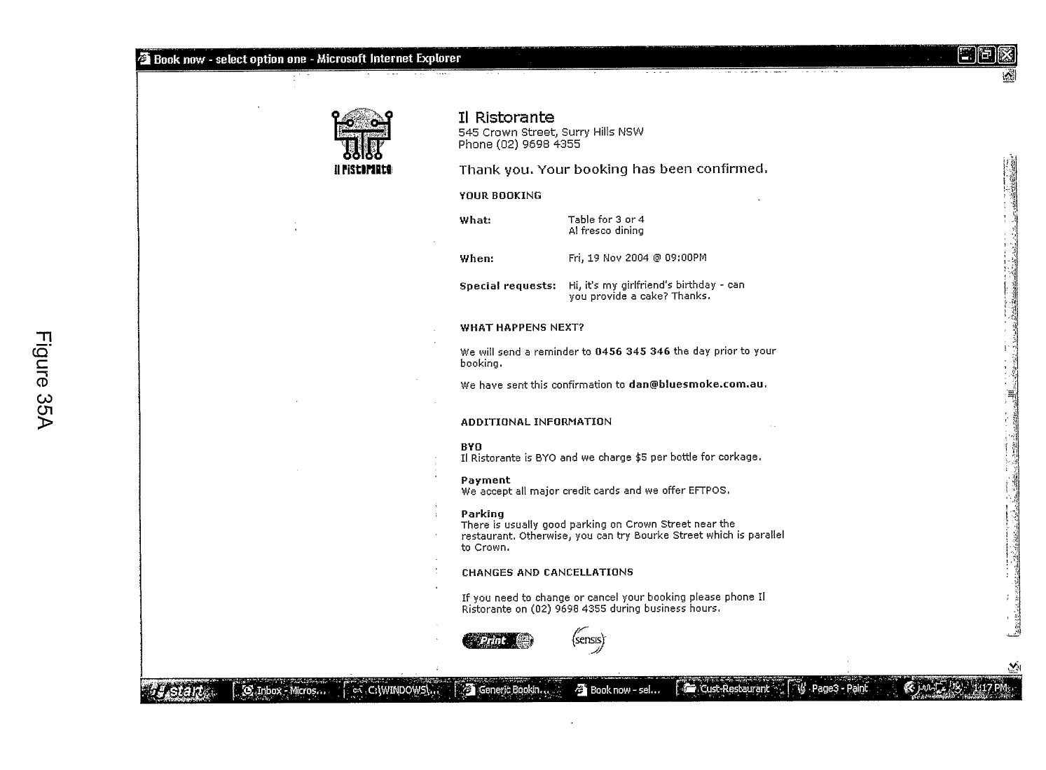

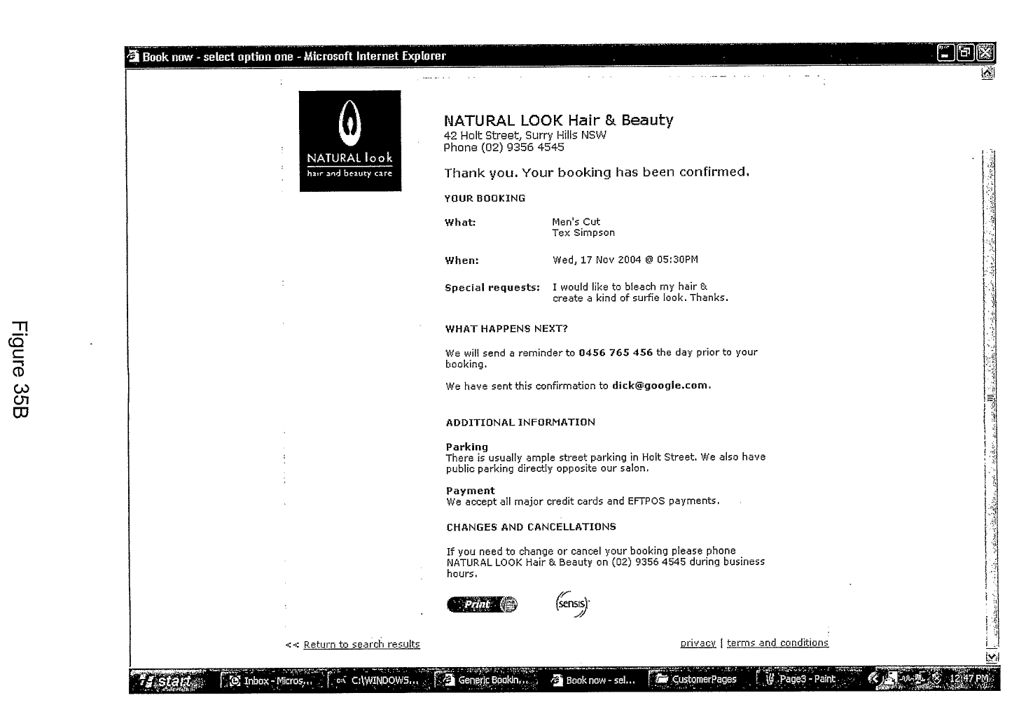

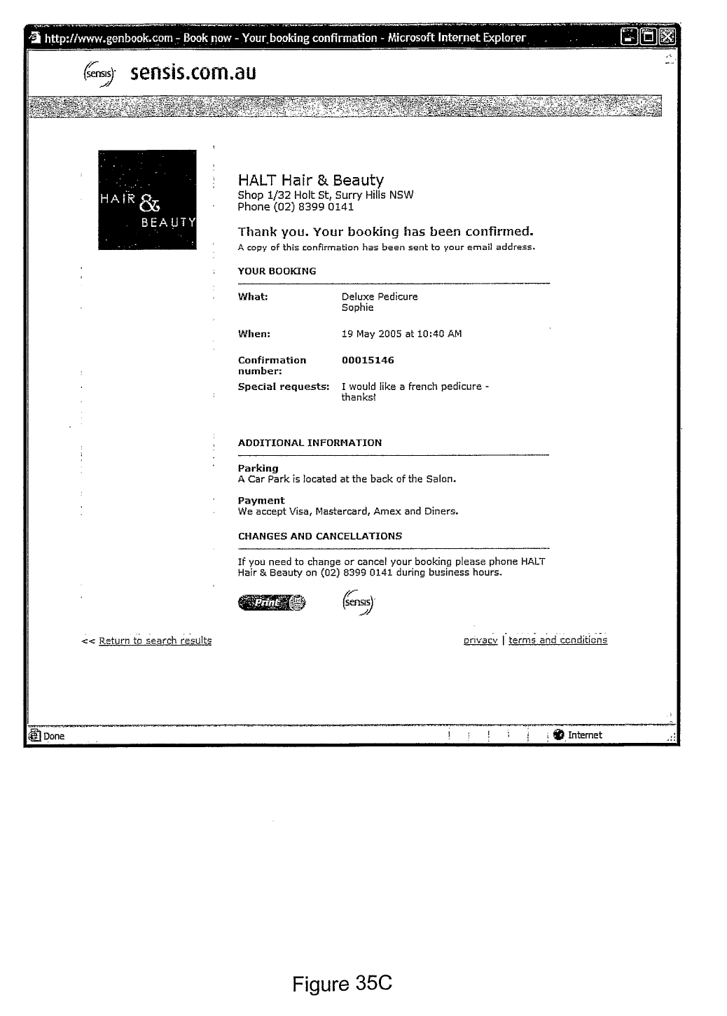

Assuming that the customer is happy with their selections, they are able to select the ‘book it now’ button, after which they are presented with the confirmation page FIGS. 35A, 35B, 35C). This confirmation page may then be printed by a user.

It can be seen that irrespective of the type of service provider, that the process and selection of particular options is substantially the same. FIG. 35C shows that a unique confirmation number is generated to facilitate easy retrieval and modification of the booking, should it prove necessary.

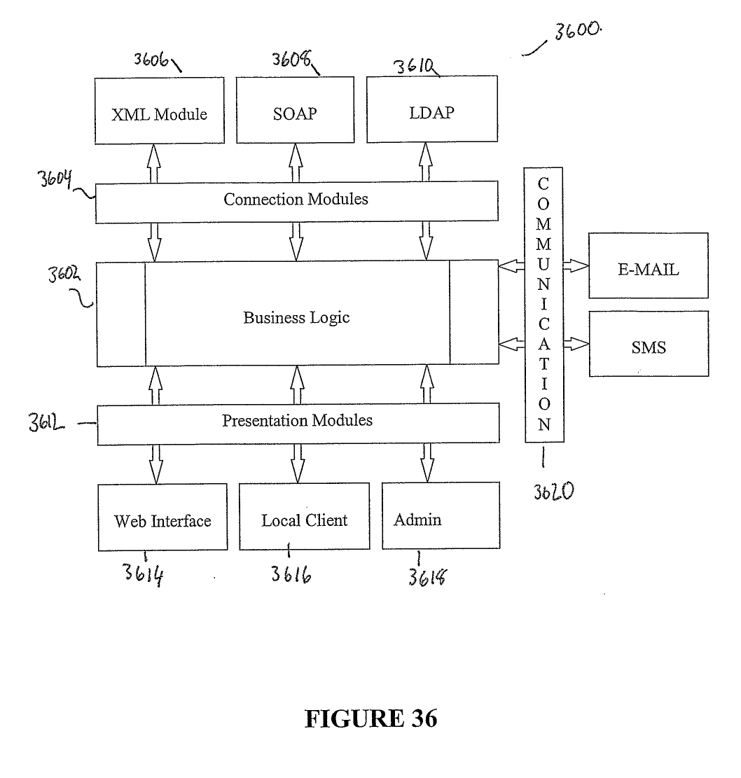

FIG. 36 shows a high level schematic representation of a computer system configured to implement a computerised method for establishing a booking facility for a plurality of different types of service providers having service provider entries included in a generic online directory listing and/or accessible via a search engine. This should be read in conjunction with FIG. 1.

In this embodiment, the computer system 3600 is a Java J2EE server application, however this could be written for any number of similar platforms for example Microsoft®.NET. Shown in FIG. 36 are a number of modules that may be utilised to access a plurality of types of data stores which may be used by search engine or directory listing providers.

An underlying business logic module 3602 provides the platform for the booking application described previously. The business logic module interfaces via a connection module 3604 with at least one of a plurality of data stores (3606,3608,3610) used by directory listing or search engine providers. (These data stores may use a variety of protocols, such as XML, SOAP or LDAP). A presentation module 3612 also interacts with the business logic module, enabling the display of the booking system over the internet 3614; as a client application 3616; or providing an administration view 3618 to the directory listing or search engine provider. Reminder or confirmation messages may be sent from the business logic module through the communication module 3620 via email and SMS to the customer of the booking system.

In still a further embodiment of the present invention, the directory or search engine provider may maintain control of the customer's experience through control of the presentation and performance of the booking service. The configuration of the customer booking interface is both flexible as it can be tailored to virtually any type of service provider, but is at the same time constrained to ensure a consistency in approach and similar overall booking experience.

A further level of granularity may be maintained by the search engine or directory listing provider. This may be achieved by providing a consistent overall look and feel, while modifying slightly the content of the setup screens depending on their context. Hence, the overall business logic remains consistent, but additional service provider categories with different displays may be provided. Four basic interface categories have been identified, with most service provider types falling into at least one of the following categories:

Restaurants;

Accommodation Providers;

Service Providers (service provision involves a person e.g. Doctors, Physiotherapists)

Service Providers (service provision is venue based and requires specific utility e.g. a tennis centre, places in a gym class).

In still a further embodiment of the present invention, the directory or search engine provider may review a number of metrics associated with each booking interface. This ensures overall consistency in the customer's booking experience and may be associated with a revenue charging model by the directory or search engine provider.

The metrics monitored could include the following:

Click Rate: Number of Clicks as overall percentage of number of times “Book Now” link is displayed on the directory or search engine provider sites. (This may also be site and/or page specific);

Success Rate: Number of actual online bookings made as a percentage of number of “clicks” on Book Now links. This could be broken down by source of bookings (e.g. directory or search engine provider site, service provider's website, etc), and could be benchmarked against the average Success Rate for other service providers of that type;

Service provider Login activity: frequency and duration of logins by Service Providers;

Service Provider operational status: status of SP (i.e., signed up, setup phase, operational but posting of “Book Now” links pending, active);

Service Provider availability: standard hours, service availability, resource availability, masked times (and any subsequently unmasked times), “Held” timeslots, online and offline bookings, online and offline bookings cancelled or deleted, lead times for online bookings);

Online bookings: volume, date & time of online bookings, service and resource booked, new or repeat customer, customer change of details, rescheduled booking.

In still a further aspect of the present invention, the Service Providers may also be provided with information by the Directory or Search Engine provider, based on information outlined above which has been captured by the Directory or Search Engine provider. This would enable the service provider to analyse the extent of the role that the online booking system and method of the present invention has in their ongoing business. This encourages the service provider to expand their online booking timeslots available, and provides them with a ready reckoner on how their business is progressing. Potentially, service providers may be able to view their statistics against average statistics of other service providers of the same type.

Various performance metrics that could be provided to the Service Provider could also include:

Success (conversion) Rate—A rate of online bookings as a percentage of “clicks” on Book Now links. This could be broken down by source of bookings and could be benchmarked against the average Success Rate for service providers of the same type.

Volume of online bookings over time—this might be illustrated using a simple line graph.

Online booking availability—this is a measure of current “online bookable hours” for each service provider. This information could be expressed in gross hours or as a percentage of the service provider schedule made available for online booking for a particular day or range of days and may calculate the days with minimum and maximum availability over a range of days, and may be represented graphically.

Popular services—a listing of the most commonly booked services online for that service provider together with the number and proportionate share each service attracts. Might be calculated over a user defined period and just the top [5] might be listed.

Average lead time for online bookings—would measure the average time between the placing of the booking and the booking date & time. This might be benchmarked against the average lead time for service providers of that type.

Any of the above information/performance metrics may be used by the Directory or Search Engine provider to implement programs that may assist the Service Provider to improve their performance. This may include determining the numbers of online bookable hours in an predetermined period that may be required to secure each online booking and comparing this figure to various other service provider figures.

Further, should the service provider log on infrequently/for short time periods, then it is possible that the Service Provider is not actively engaging with the booking system, which may detract from a consumer's overall experience and thereby their opinion of the booking system and in turn of the search engine or directory listing provider. In order to minimise the potential for a poor consumer experience, email/Short Message Service (SMS) based login reminders, with associated escalation paths if the Service Provider does not log in to their site, will allow the Directory or Search Engine provider to closely monitor each Service Provider automatically, with the capacity for human intervention should this prove necessary.

### Booking Availability Algorithm

In order to determine what times are displayed on the “Book Now” customer pages on a particular day, it is necessary to determine first the timeslots available on the requested day, and then applying an availability algorithm to the identified timeslots.

Typically, as a preliminary series of checks, the system must take into account the standard trading hours for a specified service provider on the specified date, hours that the specified resource/service is available on the specified date, whether or not the status of a particular timeslot is masked or unmasked, whether a particular timeslot has been held by a service provider.

Once a timeslot has been identified it is then necessary to apply an availability algorithm which:

optimises bookings to ensure that they are made with a minimum time increment, and are not truncated by other events such as scheduled breaks/late commencements or early conclusions of a particular resource or service;

applies start times in occurrence with service provider specified timeslots;

ensuring a selective display in the situation where there are a large number of available time slots occur in a particular day.

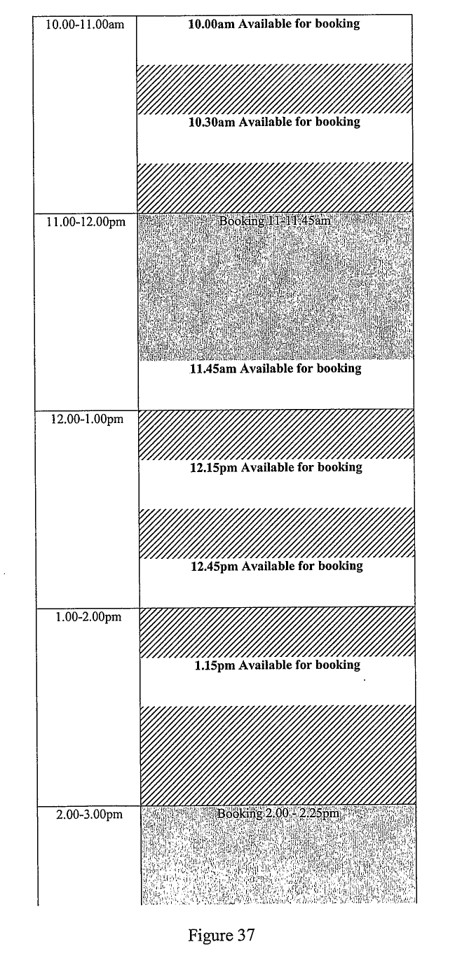

By way of example as to how this algorithm may work, the following is set out with reference to FIG. 37.

A customer has made the following request

Service: Pedicure (duration 30 minutes)

Resource: Suzie

Date: Tuesday, May 24^{th}.

The Standard trading hours for Tuesday are 9-5 pm. Pedicures are only performed from 10 am-5 pm. Suzie only works from 10 am-4 pm.

The service provider has configured an online mask for Suzie, to prevent online bookings being taken between 3 pm and 4 pm on Tuesdays. However the service provider has unmasked the 3-3.30 pm timeslot for Tuesday, May 24th.

This means, so far, that Suzie is available to perform a pedicure on Tuesday, May 24th between 10 am and 3.30 pm.

The service provider has specified the “minimum time increment” for Suzie to be 30 minutes. Possible start times are 00, 15, 30 and 45 minute marks. There is no “maximum available times” configured.

There are two existing bookings, one at 11 am with a duration of 45 minutes, and one at 2 pm with a duration of 25 minutes.

It will be understood that the invention disclosed and defined herein extends to all alternative combinations of two or more of the individual features mentioned or evident from the text or the drawings. All of these different combinations constitute various alternative aspects of the invention.

The foregoing describe embodiments of the present invention and modifications obvious to those skilled in the art can be made thereto without departing from the scope of the present invention.

1. An online booking method for providing bookings for a plurality of service providers including:
providing a plurality of bookable service provider entries with a plurality of corresponding booking links for display on a search engine results interface or a directory listing interface, said booking links including associated booking tags indicative of a booking option;
hosting a plurality of dedicated service provider booking interfaces on at least one booking engine, said booking interfaces being accessible via the corresponding booking links by selection of the associated booking tags;
receiving at the booking engine a booking request from a user, said booking request being initiated by user selection of a booking tag on said search engine results interface or directory listing interface; and
using said booking request to access a corresponding booking interface hosted on the at least one booking engine, said booking interface being populated with service provider specific details for enabling users to make a booking.

2-63. (canceled)
